(19) United States
(12) Patent Application Publication
(10) Pub. No.: US 2026/0326447 A1
(43) Pub. Date: Oct. 22, 2026

(54) LIQUID CONTAINER AND LIQUID EJECTION APPARATUS

(71) Applicant: CANON KABUSHIKI KAISHA, Tokyo (JP)

(72) Inventors: SHOKI WAKATSUKI, Tokyo (JP); MARI KIKUTANI, Kanagawa (JP); TAKAYUKI NAKAJIMA, Kanagawa (JP); TAKETSUGU MURAKAMI, Kanagawa (JP)

(21) Appl. No.: 19/641,619

(22) Filed: Apr. 8, 2026

(30) Foreign Application Priority Data
Apr. 18, 2025 (JP) 2025-069002

(51) Int. Cl. B41J 2/175

(52) U.S. Cl. CPC B41J 2/17513; B41J 2/17523; B41J 2/17553; B41J 2/17563; B41J 2002/17516

(57) ABSTRACT

A liquid container according to the present disclosure is a liquid container including: a liquid storage part configured to store a liquid; and a liquid supply member provided at a first edge of the liquid storage part, in which the liquid supply member includes a liquid supply part, the liquid supply part includes a liquid inlet portion in an inside direction of the liquid storage part, the liquid inlet portion includes a first inlet channel located in an opposite direction from a direction in which gravity is exerted in the liquid storage part, and a second inlet channel located in the direction in which gravity is exerted in the liquid storage part, and channel resistance of the second inlet channel is lower than channel resistance of the first inlet channel.

### CROSS REFERENCE TO PRIORITY APPLICATION

This application claims the benefit of Japanese Patent Application No. 2025-069002, filed Apr. 18, 2025, which is hereby incorporated by reference herein in its entirety.

### BACKGROUND

### Field of the Technology

The present disclosure relates to a liquid container and a liquid ejection apparatus using the same.

### Description of the Related Art

Liquid containers that store a liquid (in particular an ink) to be supplied to a liquid ejection apparatus, such as an inkjet printer, in a bag having flexibility have been known (such as Japanese Patent Laid-Open No. 2018-65373 (Patent Document 1), for example).

Patent Document 1 discloses a flexible liquid (in particular ink) storage body. This liquid storage body has a liquid outlet member attached to one end of a liquid storage part. Moreover, this liquid storage body has ink outlet pipes connected to an end of a spacer member extending toward the other end of the liquid storage part. Also, through outlet ports of these ink outlet pipes arranged in a center portion of the liquid storage part, the ink is taken out from a deep region inside the liquid storage part to the ink outlet member. According to Patent Document 1, the spacer member makes it possible to supply the liquid with stable concentration.

Note that arranging the ink outlet pipes in a center portion of the liquid storage part makes the ink outlet pipes long and thus uses a large amount of plastic.

For containers that use plastic, such as liquid containers, there is a demand to reduce the amount of the plastic to be used for the liquid containers in consideration of the environment. There is also a demand to reduce the amount of ink left unused in such a liquid container.

### SUMMARY

There is a need for a liquid container for supplying a liquid (such as an ink) with stable concentration that has a more space-saving outlet port for the liquid (such as an ink) than those of existing configurations.

A liquid container according to the present disclosure is a liquid container including: a liquid storage part configured to store a liquid; and a liquid supply member provided at a first edge of the liquid storage part, in which the liquid supply member includes a liquid supply part for supplying the liquid stored in the liquid storage part to an external destination, the liquid supply part includes a liquid inlet portion in an inside direction of the liquid storage part, the liquid inlet portion includes a first inlet channel located in an opposite direction from a direction in which gravity is exerted in the liquid storage part, and a second inlet channel located in the direction in which gravity is exerted in the liquid storage part, and channel resistance of the second inlet channel is lower than channel resistance of the first inlet channel.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a liquid container according to the present disclosure;

FIG. 2 is a side view of the liquid container according to the present disclosure;

FIG. 3 is a perspective view of a liquid supply member of the liquid container according to the present disclosure;

FIG. 4 is a set of views of a liquid supply member of the liquid container according to the present disclosure, (1) being a front view, (2) being a top view, (3) being a bottom view, (4) and (5) being side views;

FIG. 5A is a cross-sectional view illustrating a choked state of the liquid container according to the present disclosure, and is a view of the liquid container as seen from a side;

FIG. 5B is a cross-sectional view illustrating the choked state of the liquid container according to the present disclosure, and is a view of the liquid container as seen from the liquid supply member side;

FIG. 6A is a cross-sectional view illustrating a choked state of the liquid container according to the present disclosure provided with a ridge, and is a view of the liquid container as seen from a side;

FIG. 6B is a cross-sectional view illustrating the choked state of the liquid container according to the present disclosure provided with a ridge, and is a view of the liquid container as seen from the liquid supply member side;

FIG. 7 is a top view of the liquid container according to the present disclosure provided with a ridge;

FIG. 8 is a set of cross-sectional views of the ridge provided on the liquid container according to the present disclosure, (1) to (7) being a set of cross-sectional views illustrating variations of the ridge shape;

FIG. 9 (1) to (7) are top views illustrating variations of the ridge arrangement and shape of the liquid container according to the present disclosure provided with a ridge or ridges;

FIG. 10 is a view illustrating shapes of sealed portions of the liquid container according to the present disclosure;

FIG. 11A is a front view illustrating a configuration of the liquid supply member in the present disclosure;

FIG. 11B is a perspective view illustrating the configuration of the liquid supply member in the present disclosure;

FIG. 12A is a set of views illustrating a variation of the shape of a liquid inlet portion of the liquid container according to the present disclosure;

FIG. 12B is a set of views illustrating a variation of the shape of the liquid inlet portion of the liquid container according to the present disclosure;

FIG. 12C is a set of views illustrating a variation of the shape of the liquid inlet portion of the liquid container according to the present disclosure;

FIG. 12D is a set of views illustrating a variation of the shape of the liquid inlet portion of the liquid container according to the present disclosure;

FIG. 13A is a cross-sectional view for describing the liquid inlet portion in the present disclosure;

FIG. 13B is a cross-sectional view for describing the liquid inlet portion in the present disclosure;

FIG. 13C is a cross-sectional view for describing the liquid inlet portion in the present disclosure;

FIG. 13D is a cross-sectional view for describing the liquid inlet portion in the present disclosure;

FIG. 14A is a view illustrating a positional relationship between the liquid supply member and the sealed portions of a liquid storage part of the liquid container according to the present disclosure;

FIG. 14B is a view illustrating a positional relationship between the liquid supply member and the sealed portions of the liquid storage part of the liquid container according to the present disclosure;

FIG. 15 is a set of views of grips on the liquid supply member of the liquid container according to the present disclosure, (1) being a front view, (2) being a top view, (3) being a bottom view, (4) and (5) being side views;

FIG. 16 is a view for describing a grip on the liquid supply member of the liquid container according to the present disclosure;

FIG. 17A is a view for describing a grip on the liquid supply member of the liquid container according to the present disclosure;

FIG. 17B is a view for describing a grip on the liquid supply member of the liquid container according to the present disclosure;

FIG. 18 is a perspective view illustrating details of the liquid supply member of the liquid container according to the present disclosure;

FIG. 19 is an exploded view illustrating details of the liquid supply member of the liquid container according to the present disclosure;

FIG. 20 is a set of views illustrating variations of a memory element board in the liquid supply member of the liquid container according to the present disclosure;

FIG. 21A is a view illustrating a positional relationship between a liquid supply part and the memory element board in the liquid supply member of the liquid container according to the present disclosure;

FIG. 21B is a view illustrating a positional relationship between the liquid supply part and the memory element board in the liquid supply member of the liquid container according to the present disclosure;

FIG. 22 is a set of views illustrating variations of the positional relationship between the liquid supply part and the memory element board in the liquid supply member of the liquid container according to the present disclosure;

FIG. 23 is a perspective view of a liquid ejection apparatus using the liquid container according to the present disclosure;

FIG. 24A is a schematic view illustrating the liquid ejection apparatus using the liquid container according to the present disclosure, and is a front view of the liquid ejection apparatus;

FIG. 24B is a schematic view illustrating the liquid ejection apparatus using the liquid container according to the present disclosure, and is a side view of the liquid ejection apparatus;

FIG. 25 is a perspective view of liquid supply apparatuses for housing the liquid container according to the present disclosure;

FIG. 26 is a schematic view illustrating the liquid container according to the present disclosure and a support unit;

FIG. 27 is a perspective view illustrating a portion of a support member where a liquid injection part and an electrical contact are provided;

FIG. 28 is a set of illustrative diagrams of how the liquid container according to the present disclosure is set in and removed from the support unit; and

FIG. 29 (1) to (4) are illustrative diagrams of how the liquid container according to the present disclosure set in the support unit is set in a slot.

### DESCRIPTION OF THE EMBODIMENTS

For containers that use plastic, such as liquid containers, there is a demand to reduce the amount of the plastic to be used for the liquid containers and also to reduce the amount of ink left unused in consideration of the environment. The present inventors have considered a configuration, as one approach, in which a liquid outlet port is provided in the vicinity of an end of a liquid storage part of a liquid container instead of a configuration in which, for example, a spacer member is provided to arrange outlet ports of liquid outlet pipes of a liquid container in a center portion of the liquid storage part of the liquid container. Specifically, the present inventors have considered a configuration in which a liquid is taken out of a liquid storage part of a liquid container through a liquid outlet member provided at an end portion of the liquid storage part on one side from an end portion of the liquid outlet member on the other side (an end portion facing the inside of the liquid storage part).

However, the present inventors have found that, with the above configuration, it is difficult to supply the liquid (in particular an ink) in the liquid container always with stable concentration and the liquid is supplied with unstable concentration due to suction of the liquid with high concentration in the vicinity of the outlet port. For example, in a case where the liquid container is stored or kept unused, components in the container may settle out, making the concentration of the liquid vary in the direction of gravity inside the liquid container. In such a case, the concentration of the liquid needs to be maintained to be even if the liquid is supplied.

The present disclosure has been made in view of the above circumstance.

An embodiment of a liquid container (such as an ink pack or an ink cartridge) and a liquid ejection apparatus (referred to also as "recording apparatus" in the specification) according to the present disclosure will be specifically described below with reference to the drawings. The drawings are intended to describe embodiments of the present disclosure. Accordingly, the dimensions of members, the sizes of members relative to one another, and the like illustrated in the drawings are merely illustrative unless otherwise stated in the specification, and do not represent the actual dimensions or sizes of the liquid container, the liquid ejection apparatus (recording apparatus), and the like according to the present disclosure. It should be noted that the following embodiments are illustrative examples for carrying out the present disclosure, and the present disclosure is not limited to these configurations. Moreover, the contents described in the embodiments may be combined in part, and not all of these features are essential to the present disclosure.

In the description in this specification, directions with respect to the liquid container according to the present disclosure may be defined based on an X axis, a Y axis, and a Z axis. These axes are indicated by directional axes with arrows illustrated in drawings. Also, the direction of movement of a fluid, such as a liquid, may be indicated by a straight or curved arrow.

In this specification, in a case of specifying the direction of each axis, the direction in which the arrow on the X, Y, or Z axis points is defined as the "+" direction of the axis. That is, the "+" and "−" directions of each axis are such that the "+" direction is the direction in which the arrow points while the "−" direction is the direction opposite to the direction in which the arrow points. Moreover, in a case of referring to the direction of an axis without specifying the "+" or "−" direction, it is simply referred to as the "X-axis direction," "Y-axis direction," or "Z-axis direction."

In this specification, the height direction of the liquid container (i.e., the direction of gravity) is the Z-axis direction. The direction toward the side in the Z-axis direction (direction of gravity) toward which gravity is exerted (described also as "gravity side," "under," or "lower side" in the specification) is the +Z direction. The direction toward the opposite side from the side in the Z-axis direction (direction of gravity) toward which gravity is exerted (described also as "opposite gravity side," "above," or "upper side" in the specification) is the -Z direction.

In this specification, surfaces of members may be described as "upper surface," "top," "upper side", "bottom surface," "lower surface," "bottom," "lower side," and the like. These are such that the opposite side from the side in the Z-axis direction (direction of gravity) toward which gravity is exerted (-Z direction, opposite gravity side) will be described as "upper surface," "top," "upper side," whereas the side in the Z-axis direction (direction of gravity) toward which gravity is exerted (+Z direction, gravity side) will be described as "lower surface," "bottom," or "lower side."

In this specification, the term "liquid" includes any liquid that can be used to form and print an image or process a recording medium or the like by being applied to the recording medium. Thus, the term "liquid" in this specification is a concept encompassing any liquids that can be used in recording, printing, or processing, and includes inks and the like. Also, the concept of recording is not particularly limited and is usable in industrial applications and the like. For example, the concept of recording is usable for fabrication of biochips, printing of electronic circuits, fabrication of semiconductor substrates, and the like.

In this specification, the terms "liquid" and "ink" are used. Moreover, the terms "liquid" and "ink" represent any liquid media that can be used for formation and printing of an image, processing of a recording medium, or the like by being applied to the recording medium. Accordingly, in this specification, the terms "liquid" and "ink" are used as terms with interchangeable meanings.

In this specification, "flexible" and "having flexibility" mean being pliable and capable of being bent, or having such properties.

### (I) Liquid Container

For the description of the present disclosure, directions with respect to the liquid container are specifically defined. The direction in which gravity is exerted on the liquid container (gravity side) in a case where the liquid container is at rest is the +Z direction. The surface of the liquid container at rest facing down (the surface facing in the direction in which gravity is exerted (the surface facing in the +Z direction)) coincides with the surface of the liquid container that faces down in a case where the liquid container is mounted to the liquid ejection apparatus (recording apparatus). Also, the direction from one end of the liquid container at which a liquid supply member of the liquid container is provided toward the other end on the opposite side is the +Y direction. Thus, the direction in which the liquid container is connected to the liquid ejection apparatus (recording apparatus) in a case of mounting the liquid container to the liquid ejection apparatus is the -Y direction. Alternatively, the direction in which a later-described housing part (support unit) for housing the liquid container is pushed into the liquid ejection apparatus is the -Y direction, and the direction in which the housing part (support unit) is drawn out of the liquid ejection apparatus to a position at which the liquid container can be set and removed is the +Y direction. Moreover, a horizontal direction of the liquid container at rest is the X-axis direction, and the X axis is perpendicular to the Z axis and the Y axis. With respect to the above-described horizontal direction (X-axis direction) as seen in the above-described +Y direction, the rightward direction along the X axis is the +X direction, and the opposite direction is the -X direction (see the direction of the X-axis arrow in each drawing).

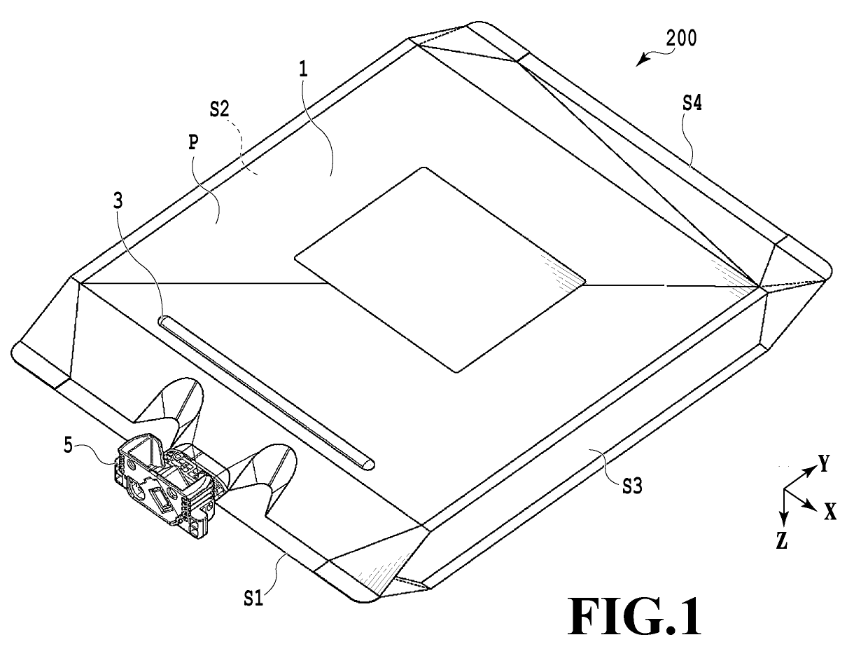

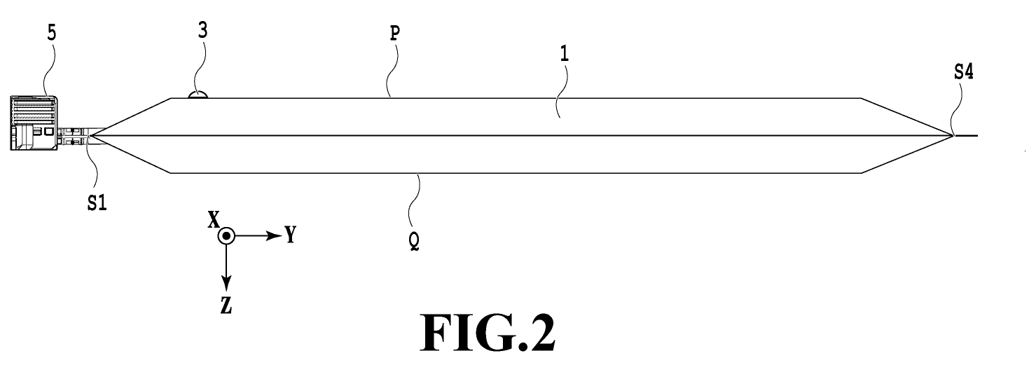

The liquid container according to the present disclosure includes a flexible liquid storage part and a liquid supply member. A liquid container 200 according to a first embodiment of the present disclosure will now be described with reference to FIGS. 1 and 2. FIG. 1 is a perspective view of an embodiment of the liquid container 200 according to the present disclosure. FIG. 2 is a side view of the liquid container 200.

As illustrated in FIG. 1, the liquid container 200 according to the present disclosure includes a flexible liquid storage part 1 and a liquid supply member 5. The liquid storage part 1 is configured to be capable of storing a liquid, such as an ink, therein. The liquid supply member 5 is a member for supplying the liquid stored in the liquid storage part 1 to an external destination.

The liquid supply member 5 is arranged at one edge of the liquid storage part 1 (first edge S1) and joined to the liquid storage part 1 by an appropriate method, such as welding.

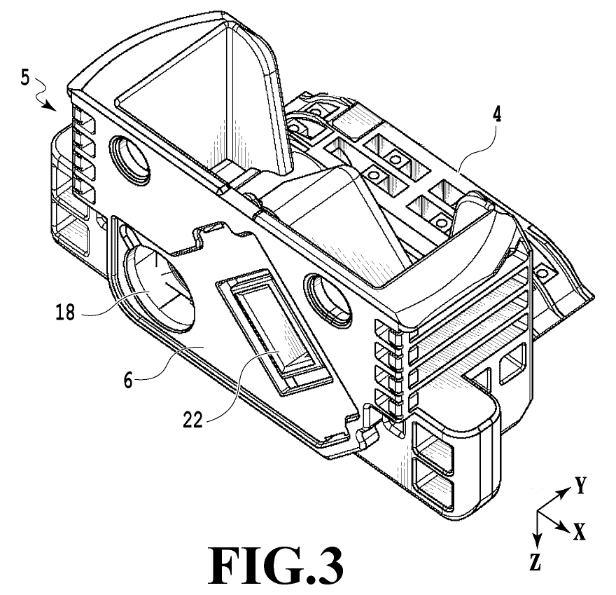

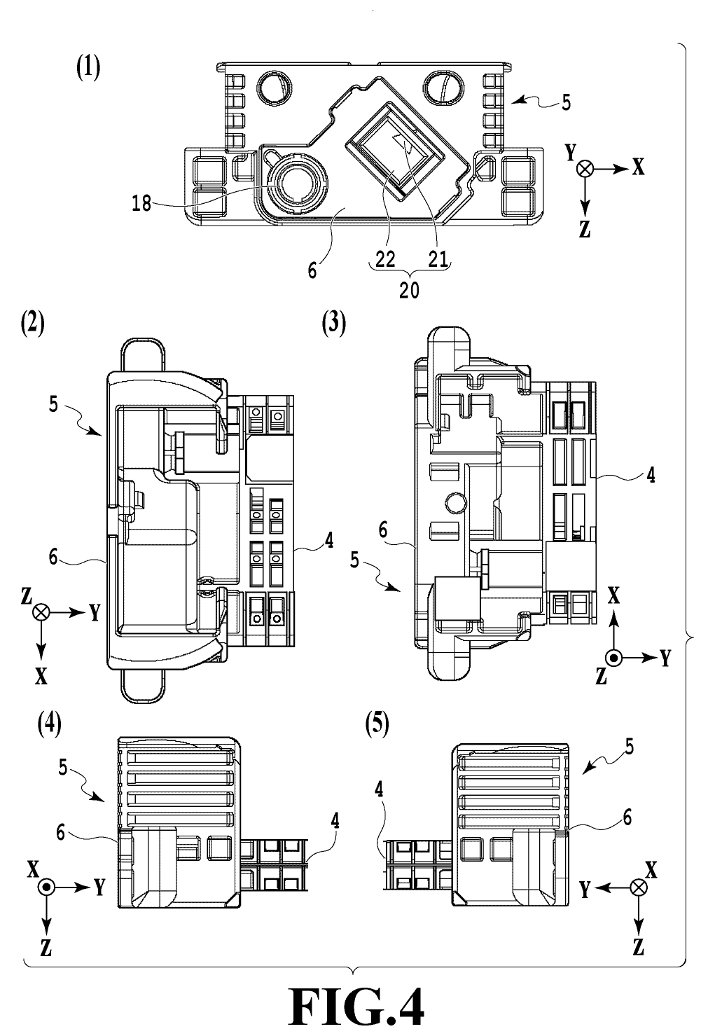

The liquid supply member 5 of the liquid container 200 according to the present disclosure will now be described with reference to FIGS. 3 and 4. FIG. 3 is a perspective view of the liquid supply member 5 in the present embodiment. (1) to (5) in FIGS. 4 are views of the liquid supply member 5 in FIG. 3 as seen from various directions. (1) in FIG. 4 is a view of the liquid supply member 5 as seen from the -Y side. (2) in FIG. 4 is a view of the liquid supply member 5 as seen from the -Z side. (3) in FIG. 4 is a view of the liquid supply member 5 as seen from the +Z side. (4) in FIG. 4 is a view of the liquid supply member 5 as seen from the +X side. (5) in FIG. 4 is a view of the liquid supply member 5 as seen from the -X side.

Details of the liquid storage part 1 and the liquid supply member 5 will be described below.

### (1) Liquid Storage Part

In the present disclosure, the liquid storage part 1 has flexibility and is configured to be capable of storing a liquid (e.g., an ink) therein. Any publicly known structure or shape may be used as long as it is capable of storing a liquid (e.g., an ink).

As illustrated in FIGS. 1 and 2, in the present embodiment, the liquid storage part 1 includes at least (1) a first surface (P) and (2) a second surface (Q) facing the first surface. The first surface (P) and the second surface (Q) share four edges of the liquid storage part 1 (the first edge S1, a second edge S2, a third edge S3, and a fourth edge S4). In the present embodiment, these four edges are the first edge S1, the second edge S2 and the third edge S3 opposing each other at the side surfaces (in the X-axis direction in FIG. 1) of the liquid storage part 1, and the fourth edge S4 opposing the first edge S1. The first surface (P) and the second surface (Q) are joined to each other at these four edges. The joining can be implemented by a publicly known joining method, such as welding. The liquid supply member 5 for supplying the liquid (e.g., an ink) stored in the liquid storage part 1 to an external destination is provided at the first edge S1 of the liquid storage part 1. As illustrated in FIGS. 3 and 4, the liquid supply member 5 includes an inner side surface 4 facing the inside of the liquid storage part 1, and an outer side surface 6 facing away from the liquid storage part 1 and located on the opposite side from the inner side surface. The liquid storage part 1 includes sealed portions illustrated in FIG. 1 (the portions of the first edge S1 in FIG. 1 curved toward the inside of the liquid storage part) at a portion of the above-described first edge S1 and around this portion. The above-described liquid supply member 5 is provided at these sealed portions. The second edge S2 and the third edge S3, which form the side surfaces of the liquid storage part 1, form (3) a first gusset surface and (4) a second gusset surface, respectively. Specifically, the first gusset surface and the second gusset surface are surfaces facing each other with the first surface (P) and the second surface (Q) therebetween. Incidentally, in the present embodiment, instead of joining the first surface (P) and the second surface (Q) with the gusset surfaces therebetween, the first and second surfaces may be directly joined by sealing.

In the present embodiment, the liquid storage part 1 can have a substantially rectangular shape with its longitudinal direction set in the Y-axis direction and its transverse direction set in the X-axis direction, but the shape is not limited to this. In the present embodiment, the shape of the liquid storage part 1 may be a different quadrangular shape, such as a trapezoidal shape or a square shape. Alternatively, the shape of the liquid storage part may be a polygonal shape such as a triangular shape or a pentagonal shape. Also, the shape of the liquid storage part may be a shape with round corners.

Also, a publicly known method may be used as the method of manufacturing the liquid storage part 1 with such a shape. Specifically, as for the method of manufacturing the liquid storage part, a pillow type in which a film is formed into a tubular shape and the top and bottom of the tube are closed may be employed. Alternatively, a three-side sealed type or a four-side sealed type in which two films are laid one over the other and their peripheral edge portions are joined to each other may be employed, or a gusset type may be employed as for the method of manufacturing the liquid storage part.

The material to be used for the liquid storage part 1 may be any publicly known material as long as the liquid storage part 1 can store a liquid (ink) therein and has flexibility. Specific examples include resin films of polyethylene terephthalate (PET), polyamide (PA), polyethylene (PE), polypropylene (PP), or the like. A film with a laminate structure obtained by laminating these films into multiple layers may be used. A coated film or a vapor-deposited film obtained by imparting a gas barrier property or a moisture barrier property to any of these resin films may be used. A film formed by laminating paper or an aluminum foil to a resin film may be used. For the purpose of storing a liquid (ink), a material capable of keeping the moisture in the liquid (ink) from evaporating is desirable. In particular, in one embodiment, an aluminum foil can be used. Also, in one embodiment, the film thickness of the film to be used as the liquid storage part 1 can be 100 μm or more and 220 μm or less.

This liquid storage part 1 may be of a size suitable for its inner volume. For example, in a case where the inner volume of the liquid storage part 1 is 1.5 L, the long side (the length in the longitudinal direction) may be approximately 374 mm, the short side (the length in the transverse direction) may be approximately 180 mm, and the width of the gusset portion provided at each side surface along the longitudinal direction may be approximately 46 mm. Alternatively, in a case where the inner volume of the liquid storage part 1 is 3.0 L, the long side (the length in the longitudinal direction) may be approximately 374 mm, the short side (the length in the transverse direction) may be approximately 240 mm, and the width of the gusset portion provided at each side surface along the longitudinal direction may be approximately 80 mm.

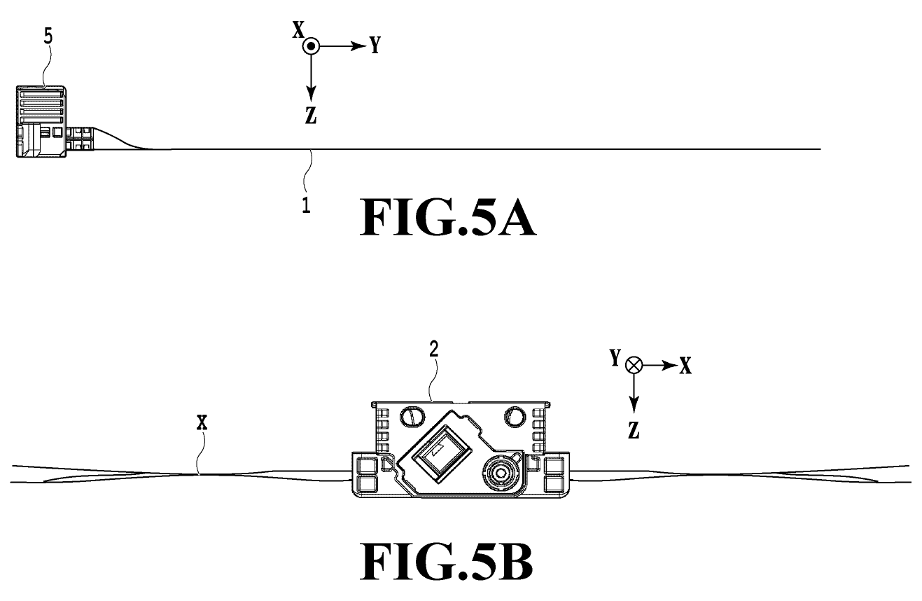

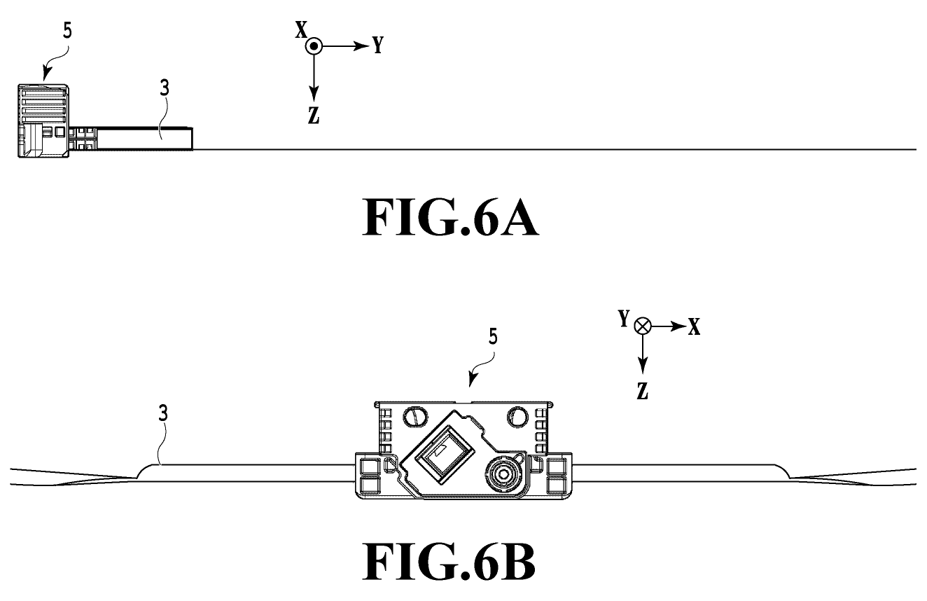

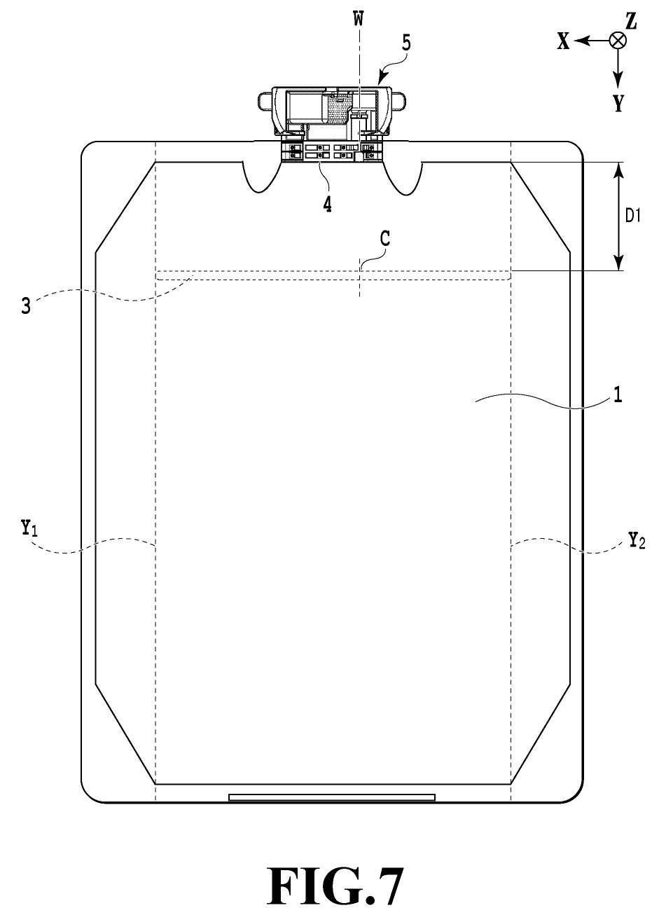

In the present disclosure, a ridge portion 3 can be provided on the first surface (P) or the second surface (Q) of the liquid storage part 1. In one embodiment, the ridge portion 3 can be formed by deforming the first surface (P) of the liquid storage part 1 by an air pressure method, a pressing method, a vacuum method, or the like. In the present disclosure, the liquid supply member 5 is provided at an end of the liquid storage part 1. Meanwhile, a liquid storage body including a liquid outlet member, a spacer member, liquid outlet pipes that guide a liquid to the liquid outlet member has been known, for example. In a case where a liquid container does not include such liquid outlet pipes or spacer member, its liquid storage part collapses as the liquid (ink) stored in the liquid storage part is consumed, which may close a path (channel) through which the liquid (ink) flows to the liquid supply member. For example, FIGS. 5A and 5B illustrate a state where a channel is closed in a case where the ridge portion 3 is not provided in the present embodiment. Specifically, reference sign X in FIG. 5B indicates a closed portion. To prevent this channel closure and fully consume the liquid (ink) stored in the liquid storage part 1, it is effective to provide the liquid storage part 1 with the ridge portion 3 to secure a channel for the liquid (ink). In one embodiment, this ridge portion 3 can be provided on the first surface (P) of the liquid storage part 1, which will be the upper surface in a case where the liquid container 200 is mounted to the liquid ejection apparatus (recording apparatus), as illustrated in FIGS. 6A and 6B. The ridge portion 3 may be provided on both the first surface (P) and the second surface (Q). Also, while the ridge portion 3 exhibits its effect regardless of where on the surface of the liquid storage part 1 the ridge portion 3 is provided, the ridge portion 3 may be provided such that it intersects a hypothetical line extending from the center axis of the liquid supply member 5. This configuration will now be described with reference to FIG. 7. FIG. 7 illustrates a transparent view of the liquid container 200 in the present embodiment as seen from the -Z side. Dotted line W in FIG. 7 represents the hypothetical line extending from the center axis of the liquid supply member 5. In FIG. 7, the ridge portion 3 is illustrated with a dotted line. Specifically, with D1 (mm) representing the distance from the inner side surface 4 of the liquid supply member 5 to an intersection between the ridge portion 3 and the hypothetical line ("C" in FIG. 7) and T₁ (mm) representing the thickness of the inner side surface 4 of the liquid supply member 5, in one embodiment, a ratio D1/T₁ can be 5/8 or more and 40/8 or less. In the present embodiment, in a case where the inner volume of the liquid storage part is 1.5 L (the long side is approximately 374 mm, the short side is approximately 180 mm, and the width of each gusset portion is approximately 46 mm), the distance D1 (mm) for the ridge portion is 20 mm, and the thickness T₁ (mm) is 8 mm. In a case where the inner volume of the liquid storage part is 3.0 L (the long side is approximately 374 mm, the short side is approximately 240 mm, and the width of each gusset portion is approximately 80 mm), the distance D1 (mm) for the ridge portion is 20 mm, and the thickness T₁ (mm) is 8 mm.

Now, consider a case where the liquid storage part 1 includes (3) a first gusset surface and (4) a second gusset surface provided respectively on the +X side and the -X side in such a way as to connect the first surface (P) and the second surface (Q), as in the present embodiment. In this case, the shortest distances from the apices (Y₁ and Y₂ in FIG. 7) of folded portions of the first gusset surface and the second gusset surface that are provided folded toward the inside the liquid storage part respectively to both ends of the ridge portion 3 can be 25 mm or less. In the present embodiment, the distances from the apices (Y₁ and Y₂ in FIG. 7) of the folded portions of the first gusset surface and the second gusset surface to both ends of the ridge portion 3 can be particularly 0 mm.

Also, in one embodiment, the length (in the X-axis direction) of the ridge portion 3 can be 80 mm or more. A long ridge portion 3 makes it easier to fully consume the liquid (ink) in end portions of the liquid storage part in the +X direction and the -X direction.

Further, in one embodiment, the width (in the Y-axis direction) of the ridge portion 3 can be 2 mm or more, and the width of the ridge portion 3 may be 8 mm or less. Furthermore, the height (in the Z-axis direction) of the ridge portion can be 0.5 mm or more, and in one embodiment, may be 4.0 mm or less. Setting the dimensions of the ridge portion 3 within these ranges will reduce misalignment between the first surface (P, upper surface) and the second surface (Q, lower surface) of the liquid storage part 1 and improve the welding between the liquid supply member 5 and the liquid storage part 1 at the portion of the liquid storage part 1 to be welded.

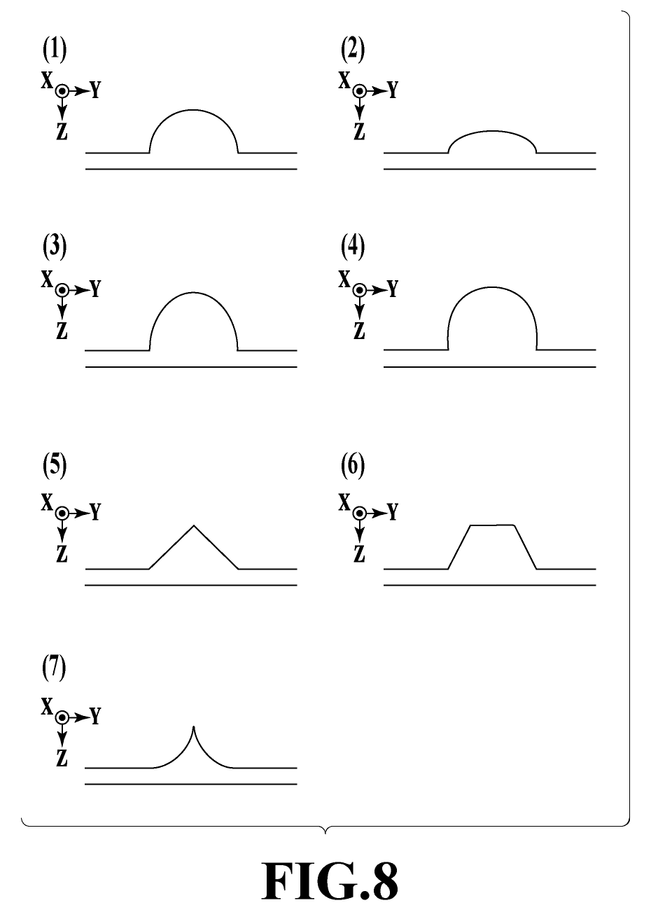

As illustrated in FIG. 8, the ridge portion 3 may have any cross-sectional shape as long as the liquid (ink) can flow. For example, the ridge portion 3 may have any of various cross-sectional shapes as illustrated in (1) to (7) in FIG. 8. In particular, the cross-sectional shape of the ridge portion 3 can be a semi-elliptical shape.

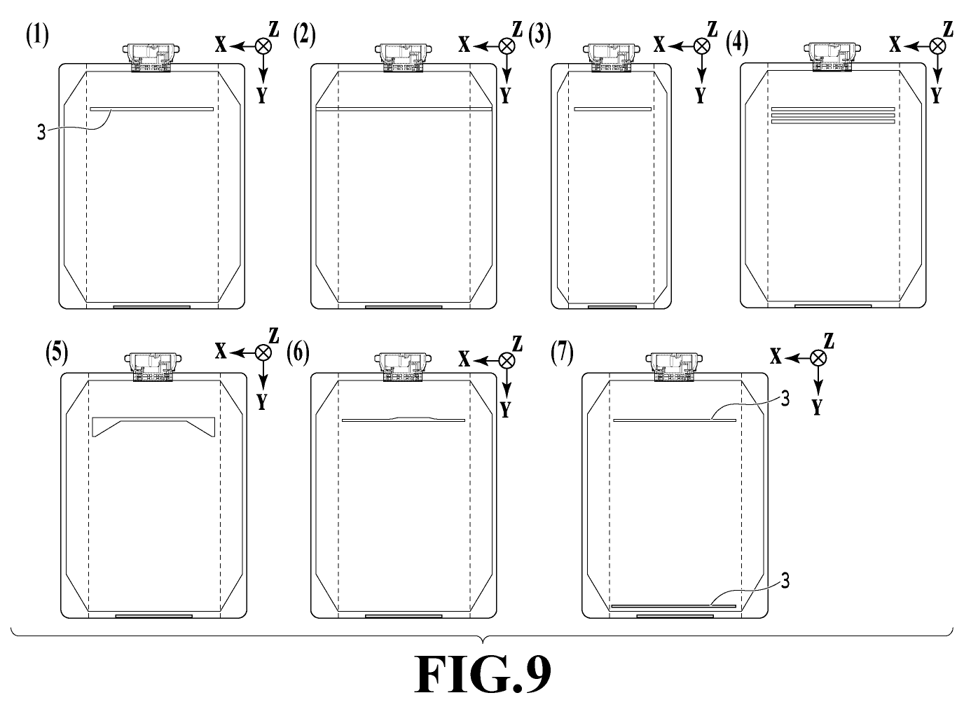

(1) to (7) in FIG. 9 illustrate shapes of the ridge portion 3 in a plan view. As illustrated in (1) to (7) in FIG. 9, any shape may be employed as long as the advantageous effects of the present disclosure can be achieved. For example, the ridge portion 3 may be provided between the apices of the above-mentioned folded portions ((1) and (3) in FIG. 9). Alternatively, the ridge portion 3 may be provided beyond the apices of the folded portions up to both side surfaces (the second edge S2 and the third edge S3) of the liquid storage part 1 ((2) in FIG. 9). Still alternatively, multiple ridge portions 3 may be provided substantially in parallel with one another ((4) in FIG. 9) or the ridge portion 3 may be formed to be partly wider in the Y-axis direction ((5) and (6) in FIG. 9). In the case of providing multiple ridge portions 3, one ridge portion may be provided on the first edge S1 side and another ridge portion may be provided on the fourth edge S4 side ((7) in FIG. 9).

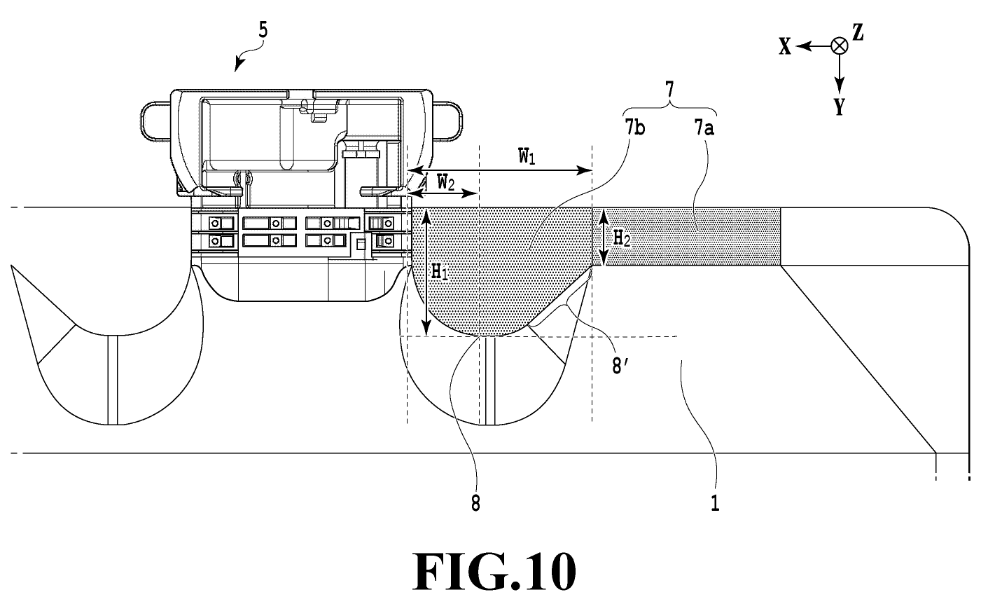

In the present embodiment, a configuration in which an outlet for a liquid (ink) is provided in the vicinity of an end portion (first edge S1) of the liquid storage part, which has flexibility, is employed, as described above. In this case, if the liquid container 200 is dropped with the liquid supply member 5 facing down, the liquid supply member 5 may be deformed by the impact of the drop in such a way as to dig into the liquid storage part 1. To avoid such a situation, one may consider, for example, a method in which the sealed portions (the portions at which the first surface (P) and the second surface (Q) are sealed) at an end of the liquid storage part 1 have a wide sealing width across the edge of the liquid storage part 1 on the side where the liquid supply member 5 is provided (the first edge S1 in the present embodiment). While this method prevents the deformation described above, it reduces the volume of a liquid (ink) that can be stored, which is not desirable. To address this, the present inventors have considered a method in which the sealing width is set to be wide only in the vicinity of the liquid supply member 5. Here, the present inventors have found that, in a case where the shape of the portions where the sealing width is set to be wide is rectangular, the sealing will be easy but stress tends to concentrate at the corner portions and the corner portions may break. With the above circumstances taken into account, the present inventors have considered the shape, arrangement, and so on of the portions where the sealing width is set to be wide in more detail. As a result, it has been found desirable that sealed portions 7 of the first surface (P) and the second surface (Q) each have the following configuration, as illustrated in FIG. 10. Specifically, the followings can be included: (a) a first sealed portion 7a in a rectangular shape parallel to the first edge S1; and (b) a second sealed portion 7b arranged between the first sealed portion and the liquid supply member, formed to be continuous with the first sealed portion in the direction parallel to the first edge, and having a convex shape pointing at the inside of the liquid storage part (+Y side). These sealed portions 7 can be provided in such a way as to sandwich the liquid (ink) supply member 5 at the first edge S1 of the liquid storage part from both sides.

As illustrated in FIG. 10, an apex 8 of the convex shape of the second sealed portion 7b can be arranged such that a distance W₂ (mm) to the apex 8 from the liquid supply member 5 in the direction parallel to the first edge S1 is less than W₁/2, where W₁ (mm) is the full width of the convex shape. Also, with H₁ (mm) representing the height of the convex apex 8 from the end of the first edge S1, the ratio of H₁ to W₂ (H₁/W₂) can be 1.5 or more, and in one embodiment, may be 1.8 or more and 2.2 or less. The larger H₁ is with respect to W₂, the higher the effect of preventing the liquid supply member 5 from digging into the liquid storage part 1 at the time of being dropped.

Further, with H₂ (mm) representing the height of the first sealed portion 7a from the first edge S1, in one embodiment, H₁ and H₂ can satisfy 1.8 ≤ (H₁ - H₂)/H₂ ≤ 2.2.

While it suffices that the shape of these sealed portions 7 is a convex shape, the outer edge of the convex shape of the second sealed portion 7b from the apex 8 to the liquid supply member 5 can include a curved portion with a radius of curve R of 10 mm or more. Further, the outer edge can include a curved portion with a radius of curve R of 10 mm or more and 15 mm or less. By including such a curved portion, the stress generated upon a drop will be distributed to a greater extent.

The outer edge of the convex shape of the second sealed portion 7b from the apex 8 to the portion at which the first sealed portion 7a and the second sealed portion 7b are connected can include a straight portion 8'.

As described above, the sealed portions 7 can be provided on both sides of the liquid supply member 5 at the first edge S1 of the liquid storage part 1, in which case the distance between the apices 8 of the convex shapes of the sealed portions 7 on both sides can be within the following value ranges. Specifically, the distance can be 70 mm or more and 90 mm or less, and in one embodiment, may be 75 mm or more and 85 mm or less. Additionally, the distance between the ends of the convex shapes on the liquid (ink) supply member side can be 40 mm or more and 70 mm or less, and in one embodiment, may be 45 mm or more and 60 mm or less.

### (2) Liquid Supply Member and Liquid Supply Part

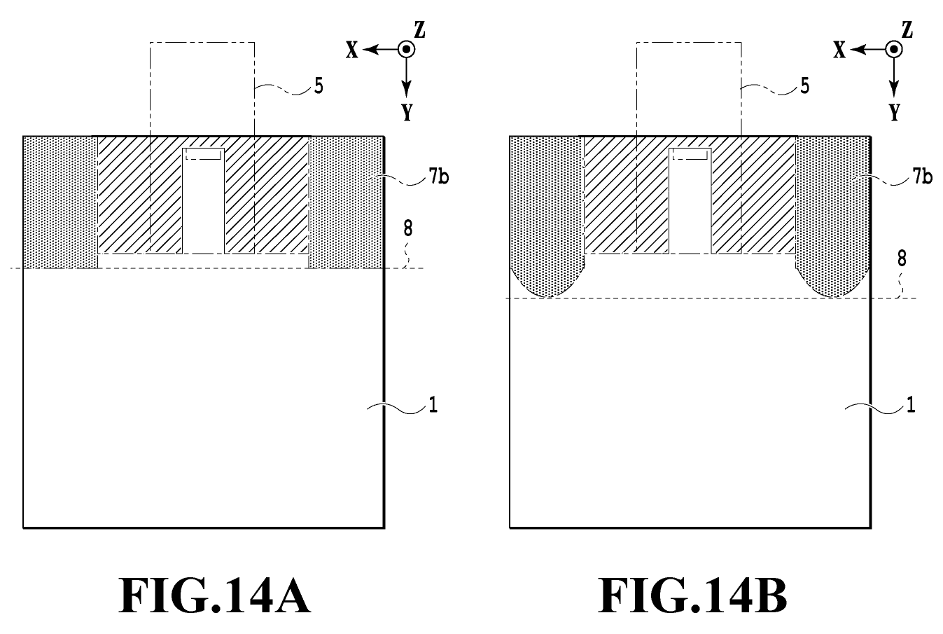

In the present disclosure, the liquid supply member 5 may have any structure or shape as long as it is configured to supply the liquid (e.g., an ink) stored in the liquid storage part 1 to an external destination. In the present disclosure, as described above, the liquid supply member 5 is provided at the first edge S1 (first edge) of the liquid storage part 1 for the purpose of reducing the amount of plastic to be used for the liquid container 200. Incidentally, cases where the liquid supply member 5 is arranged in sealed portions at the first edge S1 will be described later using FIGS. 14A and 14B. In the present disclosure, the liquid supply member 5 can have a size within a predetermined range relative to the liquid storage part 1 for the purpose of reducing the amount of plastic. For example, the liquid storage part 1 includes the above-described first edge (first edge S1) and a second edge opposing the first edge (corresponding to the above-described fourth edge S4). Suppose that the length of the liquid storage part 1 in a direction from the first edge (first edge S1) toward the second edge (fourth edge S4) is LA (the length LA represents the length of the liquid storage part 1 in the Y-axis direction). Suppose also that the liquid supply member 5 has a length LB in the same direction from the first edge (first edge S1) to the second edge (fourth edge S4) of the liquid storage part 1 (the length LB represents the thickness of the liquid supply member 5 in the Y-axis direction). These lengths LA and LB can have a relationship of LA/LB > 3.4.

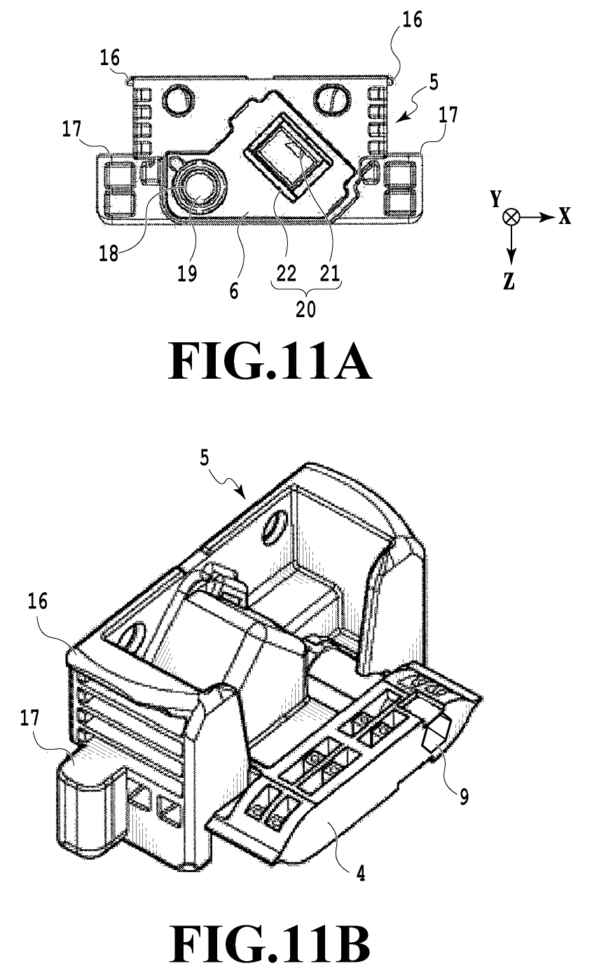

FIGS. 11A and 11B illustrate schematic views of the liquid supply member 5 in the present embodiment. FIG. 11A is a front view of the liquid supply member 5. FIG. 11B is a perspective view of the liquid supply member 5. In the present embodiment, as illustrated in FIG. 11A, the liquid supply member 5 includes a liquid supply part 18 for guiding the liquid stored in the liquid storage part 1 to the outside, and an electrical connection part 20. The liquid supply member 5 and the liquid supply part 18 are formed integrally with each other. Note that the liquid supply part 18 may be formed separately from the liquid supply member 5 and joined to the liquid supply member 5. The liquid supply part 18 includes a first end 9 (FIG. 11B) on the side of the liquid supply member 5 facing the inside of the liquid storage part 1 (+Y side), and a second end 19 (FIG. 11A) on the side opposing this first end 9 (the side facing away from the liquid storage part 1 (-Y side)).

The liquid supply part 18 and the liquid supply member 5 will be described below in more detail.

### (2-1) Liquid Supply Part

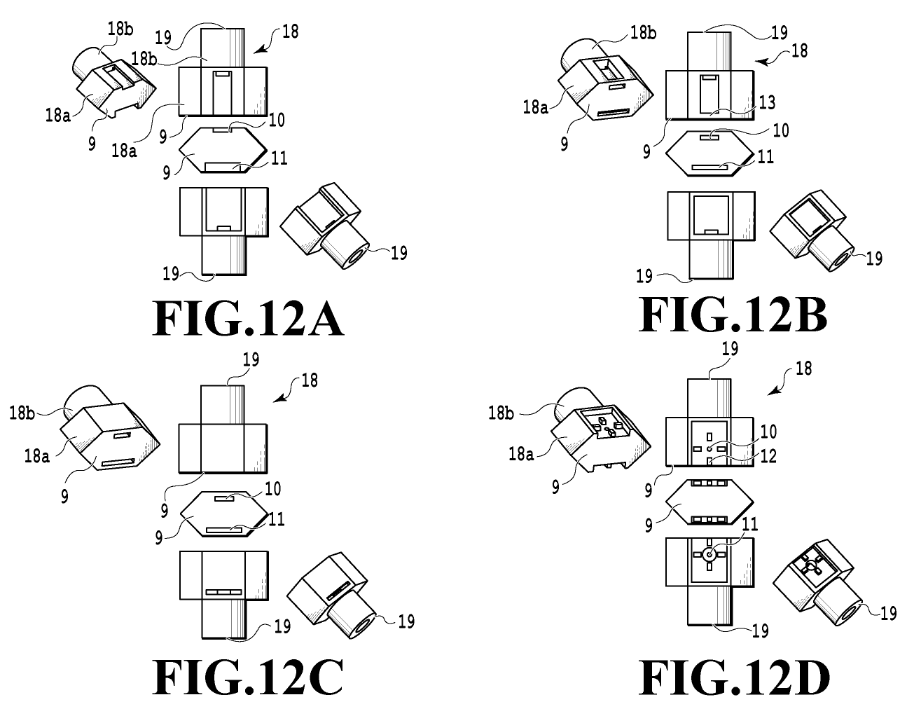

It suffices that the liquid supply part 18 is configured to take in the liquid (e.g., an ink) stored in the liquid storage part 1. For example, in the present disclosure, as illustrated in FIGS. 12A-12D, the liquid supply part 18 includes a liquid inlet portion 18a including the first end 9 and a liquid outlet portion 18b including the second end 19. The liquid inlet portion 18a and the liquid outlet portion 18b can be formed integrally with each other but may be formed by forming them separately and joining them. The liquid supply part 18 is included on the inside of the liquid storage part 1 (on the side where the liquid is stored).

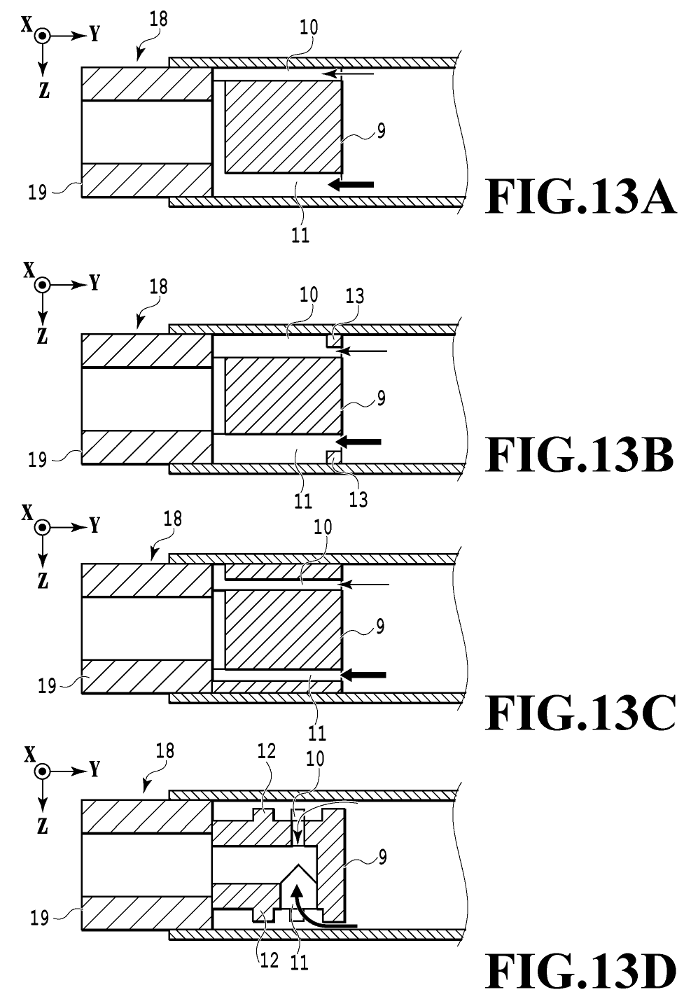

The liquid supply part 18 will be described below with reference to FIGS. 12A-12D and 13A-13D.

FIGS. 12A-12D are development views for illustrating the liquid supply part 18 in the present embodiment. As described above, the liquid supply part 18 can be formed of the liquid inlet portion 18a and the liquid outlet portion 18b. As illustrated in FIGS. 12A and 12B, the liquid inlet portion 18a includes two liquid inlet channels (a first inlet channel 10 and a second inlet channel 11) that guide the liquid in the liquid storage part 1 into the liquid supply part 18. FIGS. 12A to 12C represent examples in which the first inlet channel 10 and the second inlet channel 11 are provided from the first end 9 of the liquid inlet portion 18a toward the liquid outlet portion 18b. More specifically, FIG. 12A illustrates a case where these inlet channels 10 and 11 are provided along the upper surface (-Z side) and lower surface (+Z side) of the liquid inlet portion 18a from the first end 9 side. FIG. 12B represents an example in which a beam portion 13 is provided to the inlet channels 10 and 11 in the configuration in FIG. 12A. The beam portion 13 is provided to one or both of the first inlet channel 10 and the second inlet channel 11, and in one embodiment, can be provided on the first end 9 side of the liquid inlet portion 18a. FIG. 12C represents an example in which a wall is provided over at least one of the first inlet channel 10 or the second inlet channel 11. FIG. 12D illustrates an example in which the entrance portions (openings) of the first inlet channel 10 and the second inlet channel 11 are provided in the upper surface (-Z side) and lower surface (+Z side) of the liquid inlet portion 18a, respectively.

In a case where the liquid container 200 is left at rest, the concentration of the liquid (ink) in the liquid storage part 1 may become uneven. In such a case, supplying the liquid (ink) with high concentration to the liquid ejection apparatus (recording apparatus) may cause a decrease in ejection stability or the like. For this reason, the liquid supply part 18 can have a configuration that makes the concentration of the liquid (ink) even in the vicinity thereof. One may consider, for example, providing a mechanism that agitates the inside of the liquid container 200, but doing so makes the container complicated and is therefore not desirable. Hence, in the present embodiment, the liquid supply part 18 with a structure as illustrated in any of FIGS. 12A-12D described above is used.

Next, the liquid inlet channels (first inlet channel 10 and second inlet channel 11) according to the present disclosure will be described in further detail with reference to FIGS. 13A-13D. As illustrated in FIGS. 13A-13D, the liquid inlet channels (first inlet channel 10 and second inlet channel 11) are channels in the liquid inlet portion 18a through which to cause the liquid to flow from the first end 9 of the liquid inlet portion 18a toward the second end 19 of the liquid outlet portion 18b. The walls of these channels on the first surface (P) side and the second surface (Q) side can be formed by walls of the liquid storage part 1 (in particular the first surface (P) and the second surface (Q)) (FIGS. 13A, 13B, and 13D). A wall may be provided over one or both of the inlet channel 10 and the inlet channel 11 (FIG. 13C illustrates an example in which a wall is provided over each of the two inlet channels). Further, each inlet channel may be formed such that the entrance portions of the first inlet channel 10 and the second inlet channel 11 may be formed to face upward (-Z direction, opposite gravity side) in the direction of gravity (Z-axis direction) and downward (+Z direction, gravity side) in the direction of gravity (Z-axis direction) (FIG. 13D). Thus, the entrances of the liquid inlet channels may be oriented in the +Y direction as illustrated in FIGS. 13A-13C or oriented in the +Z direction and the -Z direction as illustrated in FIG. 13D. In the case where the entrances are oriented in the +Z direction and the -Z direction, the risk of choking is higher than in the case where the entrances are oriented in the +Y direction. Thus, it is desirable to provide choking prevention ribs 12 in the vicinity of the suction openings.

As illustrated in FIGS. 13A-13D, of the inlet channels (first inlet channel 10 and second inlet channel 11) according to the present disclosure, the first inlet channel 10 is provided at a position on the upper side (-Z side) in the direction of gravity (Z-axis direction). Of the inlet channels (first inlet channel 10 and second inlet channel 11), the second inlet channel 11 is provided at a position on the lower side (+Z side) in the direction of gravity (Z-axis direction). In the present disclosure, the first inlet channel 10 and the second inlet channel 11 can differ from each other in channel resistance. In particular, the channel resistance of the second inlet channel 11 may be lower than that of the first inlet channel 10. For example, a difference in channel resistance may be created by means of the size of the opening (e.g., the opening area) of each channel. Alternatively, a difference in channel resistance may be created by means of the length of each inlet channel. In these specific examples, the size of the opening of the first inlet channel 10 is smaller than the size of the opening of the second inlet channel 11, and the length of the first inlet channel 10 is shorter than the length of the second inlet channel 11, for instance. As described above, in a case where the liquid container 200 is placed at rest, the concentration of the liquid (ink) may become higher in the +Z direction, which is the direction in which gravity is exerted, than in the -Z direction. In this case, the denser liquid (ink) has higher viscosity, making it more difficult to suck this liquid (ink) into the inlet channel. For this reason, the opening of the inlet channel on the +Z side, into which it is more difficult to suck the liquid, may be made larger (e.g., the opening area may be made larger) to create a difference between the liquid suction into the liquid inlet channel in the liquid inlet portion 18a on the +Z side and that on the -Z side. This makes it possible to suck the liquid (ink) in such that the liquids flowing in from the openings of the respective inlet channels will be even in concentration (a state where the concentration ratio between the liquid from the liquid inlet channel on the +Z side and that on the -Z side is close to 1:1 representing no concentration difference).

Next, the positional relationship between the liquid supply part 18 and the first edge S1 of the liquid storage part 1 will be described with reference to FIGS. 14A and 14B. FIG. 14A illustrates a case where the shape of the second sealed portion 7b is a rectangular shape. FIG. 14B illustrates a case where the shape of the second sealed portion 7b is a shape including a circular shape. As illustrated in FIGS. 14A and 14B, the first end 9 of the liquid supply member 5, which includes the first inlet channel 10 and the second inlet channel 11, can be located on the -Y side relative to the apex 8 of the second sealed portion 7b (that is, the first end can be located inward of the sealed portions 7). This is to prevent concentration of the impact of a drop of the liquid container 200 at the liquid supply member 5. Further, the drop impact to the liquid supply member 5 is distributed by the sealing at the first edge S1 of the liquid storage part 1. This reduces the impact to be applied to the liquid supply member 5. Also, in the present embodiment, the liquid storage part 1 includes no structural objects therein. This prevents penetration of a structural object inside the liquid storage part 1 therethrough due to a drop, breakage of a structural object itself due to a drop, and the like. In addition, the first surface (P) and the second surface (Q) of the liquid storage part 1 in the vicinity of the liquid supply member 5 are fixed by the sealed portions 7. This prevents a phenomenon in which the above two surfaces of the liquid storage part 1 close the entrances of the inlet channels 10 and 11 during suction of the liquid.

Also, as described earlier, the entrances of the liquid inlet channels are located on the -Y side relative to the apex 8 of the second sealed portion 7b. This makes it possible to suck the liquid (ink) in such that the liquid will be delivered in a stable state (a state where the concentration ratio between the liquid from the liquid inlet channel on the +Z side and that on the -Z side is close to 1:1 representing no concentration difference) until being fully consumed. In the case of a configuration in which the entrances of the inlet channels are provided inside the liquid storage part 1, a phenomenon may occur in which the inner sides of the first surface (P) and the second surface (Q) of the liquid storage part 1 get attached to the entrances as the liquid (ink) gets sucked in. This breaks the balance in channel resistance between the entrance on the +Z side and the entrance on the -Z side. In the present embodiment, the liquid storage part 1 does not get attached to the entrances of the liquid inlet channels. Hence, the balance in channel resistance will be maintained until the liquid (ink) is fully consumed. In order to further reduce this attachment, beam portions 13 as illustrated in FIGS. 12B and 13B may be provided on the first end 9 side of the liquid inlet channels.

The liquid (ink) in the liquid storage part 1 has, of course, been processed not to contain foreign substances, such as dust. Nonetheless, foreign substances may still be included unintentionally during the manufacturing process. The liquid supply part 18 can function as a filter in order to keep them from moving into the liquid ejection apparatus (recording apparatus). In practice, as the filter, a mesh filter or the like may be attached to the entrances of the inlet channels.

### (2-2) Liquid Supply Member

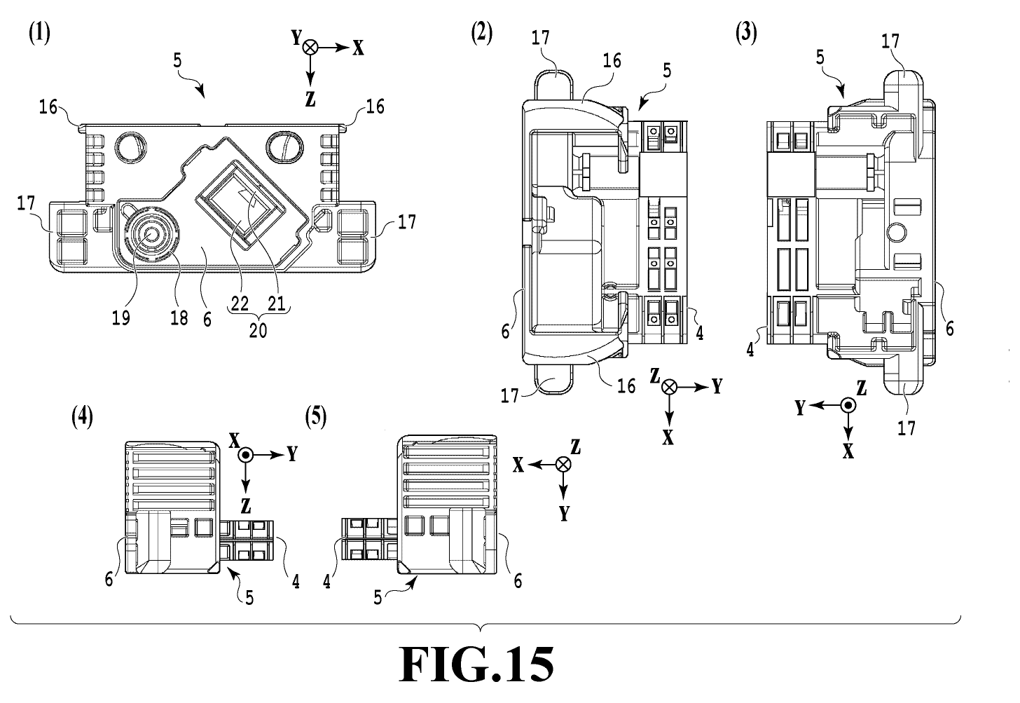

The liquid supply member 5 will be described below with reference to FIGS. 15-22. As illustrated in FIG. 15, the liquid supply member 5 includes first protruding portions 16 and second protruding portions 17.

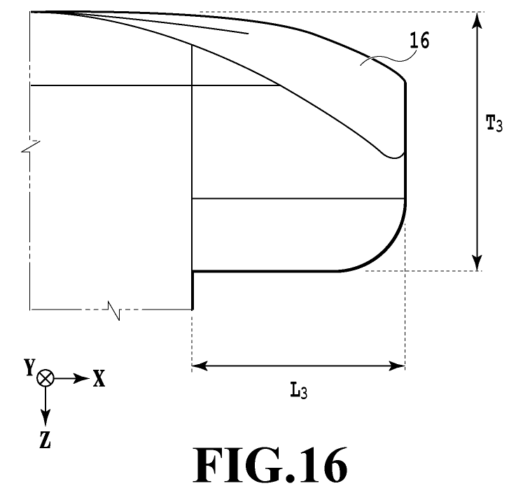

The liquid supply member 5 can include the first protruding portions 16, which protrude respectively in the +X direction and the -X direction, at an end portion in the -Z direction (an upper end portion in a case where the liquid container 200 is at rest, i.e., an end portion closer to the first surface (P) of the liquid storage part 1) (see FIG. 15(2), for example). The provided first protruding portions 16 may serve as grips on which the user holds the liquid container 200. In particular, to reduce the amount of plastic to be used for the liquid container 200, it is desirable to employ a simple mechanism as this for the user to grip the liquid container 200. Also, from the viewpoint of reducing the amount of plastic, the width of the first protruding portions 16 in the X-axis direction (width of protrusion, amount of protrusion) can be 3.0 mm or less. Moreover, the width of the first protruding portions 16 in the Z-axis direction (thickness) can be 3.0 mm or less. The lower limit for each width can be 1.0 mm or more from the viewpoint of the strength of the grips. FIG. 16 illustrates an enlarged plan view of a first protruding portion 16 as seen from the -Y side. In FIG. 16, L₃ represents the width of the first protruding portion 16 in the X-axis direction (width of protrusion, amount of protrusion), and T₃ represents the width of the first protruding portion 16 in the Z-axis direction (thickness).

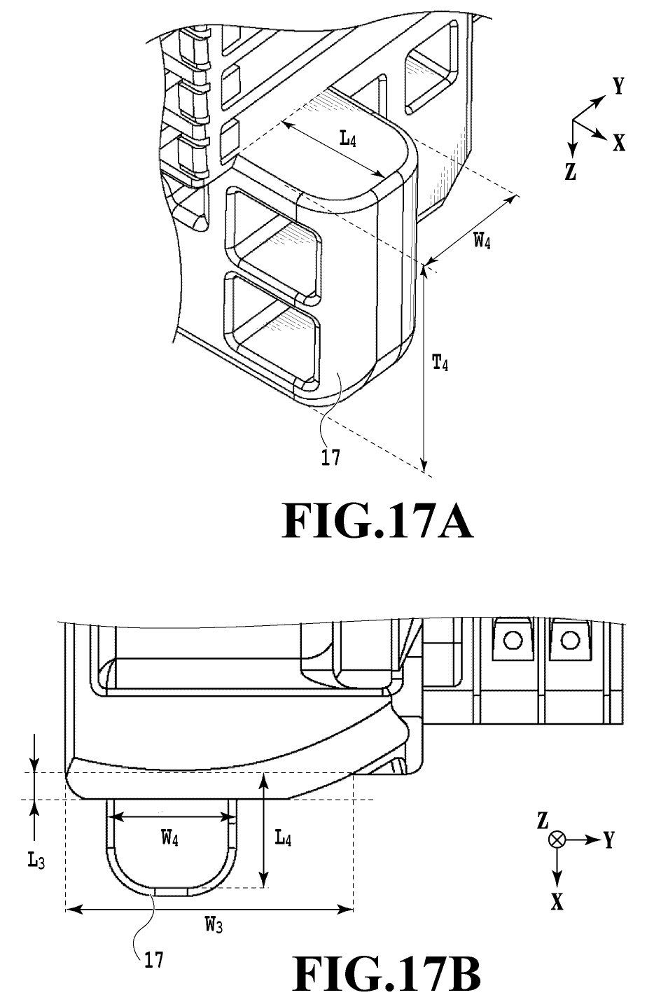

The liquid supply member 5 also includes the second protruding portions 17, as illustrated in FIGS. 15 and 17A and 17B. FIG. 17A is an enlarged perspective view of a second protruding portion 17. FIG. 17B is an enlarged plan view of the second protruding portion 17. As illustrated in FIGS. 15 and 17A and 17B, the liquid supply member 5 can include the second protruding portions 17, which protrude respectively in the +X direction and the -X direction, at an end portion the +Z direction (a lower end portion in a case where the liquid container 200 is at rest, or an end portion closer to the second surface (Q) of the liquid storage part 1). Providing the second protruding portions 17 makes it easier to position the liquid container 200 with respect to the liquid ejection apparatus (recording apparatus) to be described later at the time of mounting the liquid container 200 to the liquid ejection apparatus (recording apparatus). A width L₄ of the second protruding portions 17 in the X-axis direction (width of protrusion, amount of protrusion) can be 3.0 mm or more and 10.0 mm or less, and in one embodiment, may be 5.0 mm or more and 9.0 mm or less. Further, a width T₄ of the second protruding portions 17 in the Z-axis direction (thickness) can be 3.0 mm or more and 20.0 mm or less and, in one embodiment, may be 5.0 mm or more and 16.0 mm or less. Furthermore, a width W₄ of the second protruding portions 17 in the Y-axis direction can be 3.0 mm or more and 10.0 mm or less, and in one embodiment, may be 5.0 mm or more and 10.0 mm or less.

In particular, the amount of protrusion of the second protruding portions 17 in the +X direction and the -X direction can be larger than that of the first protruding portions 16. Satisfying such a relationship enables the user to see the ends of the second protruding portions 17 to be positioned from above while gripping the first protruding portions 16 while mounting the liquid container 200 to the liquid ejection apparatus (recording apparatus). This makes it easier to mount the liquid container 200 to the liquid ejection apparatus (recording apparatus) (enhances the viewability during mounting). Further, the width of the first protruding portions 16 in the +Y direction can be wider than the width of the second protruding portions 17. Such a configuration is desirable as it enhances the viewability during mounting.

The ratio of the amount of protrusion of the first protruding portions 16 in the X-axis direction and the amount of protrusion of the second protruding portions 17 in the X-axis direction (first protruding portions/second protruding portions) can be 1/10 or more and less than 1, and in one embodiment, may be 1/10 or more and 1/3 or less.

The ratio of the width of the first protruding portions 16 in the Y-axis direction and the width of the second protruding portions 17 in the Y-axis direction (first protruding portions/second protruding portions) can be 3/22 or more and less than 1, and in one embodiment, may be 5/22 or more and 10/22 or less.

Further, the ratio of the width of the first protruding portions 16 in the Z-axis direction (thickness) and the width of the second protruding portions 17 in the Z-axis direction (thickness) (first protruding portions/second protruding portions) can be 1/16 or more and 3/5 or less.

Also, the shapes of the first protruding portions 16 and the second protruding portions 17 as seen from the -Z side may be any shapes. For example, the shape of the first protruding portions 16 as seen from the -Z side can be a shape that is tapered (tilted) toward the +Y side, as illustrated in FIG. 17B. Also, the shape of the second protruding portions 17 as seen from the -Z side can be a shape with no angular portion (FIG. 17B).

Further, the shape of the first protruding portions 16 as seen from the -Y side can be a shape that is tapered (tilted) to extend downward in the +Z direction, as illustrated in FIG. 16. This is because the user's fingers access the first protruding portions 16 from the -Z side.

### Liquid Supply Part and Electrical Connection Part

The liquid supply member 5 can include the liquid supply part 18 configured to be capable of supplying a liquid in a case where it is connected to a later-described liquid injection part 1005 provided to the main body of the liquid ejection apparatus. The liquid supply part 18 can be provided at an end portion of the liquid supply member 5 in the -Y direction, i.e., an end portion of the liquid container 200 in the -Y direction.

The configuration of the liquid supply part 18 may be any configuration as long as it includes an opening at the second end 19 (FIG. 11A) and can supply a liquid to the liquid ejection apparatus with the liquid injection part 1005 of the liquid ejection apparatus inserted into this opening. The shape of the opening may be any shape, but may be a circular shape (including an elliptical shape).

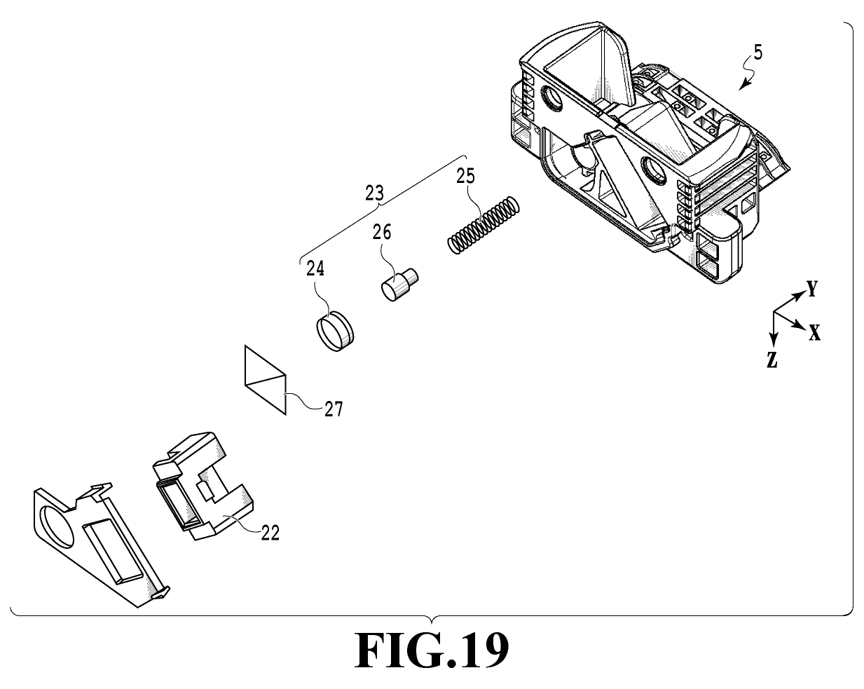

The liquid supply part 18 may include a sealed portion, a valve portion, and the like in order to prevent the liquid (ink) from leaking out in a state where the liquid injection part 1005 of the liquid ejection apparatus is not inserted (i.e., a state before using the liquid container 200). The structure of the sealed portion and the valve portion may be any publicly known structure. Examples thereof include a valve spring structure, a slit valve, and so on. In the present embodiment, as illustrated in FIG. 19, which is an exploded perspective view of the liquid supply member 5, the liquid supply member 5 includes a valve mechanism 23 that opens and closes in response to attaching or detaching the liquid supply member 5 to or from the liquid ejection apparatus. Specifically, an opening and closing mechanism can be provided by pressing a valve 26 against an elastic seal member 24 with a biasing member 25, such as a spring.

Also, a mechanism may be employed that includes a film 27 or the like attached to the opening in a state where the liquid container 200 is yet to be used by the user and, in a case where the liquid injection part 1005 of the liquid ejection apparatus is inserted into the opening, the film gets ripped, allowing fluid communication between the liquid ejection apparatus and the inside of the liquid storage part 1. Such a mechanism effectively prevents the liquid (ink) from leaking out before use.

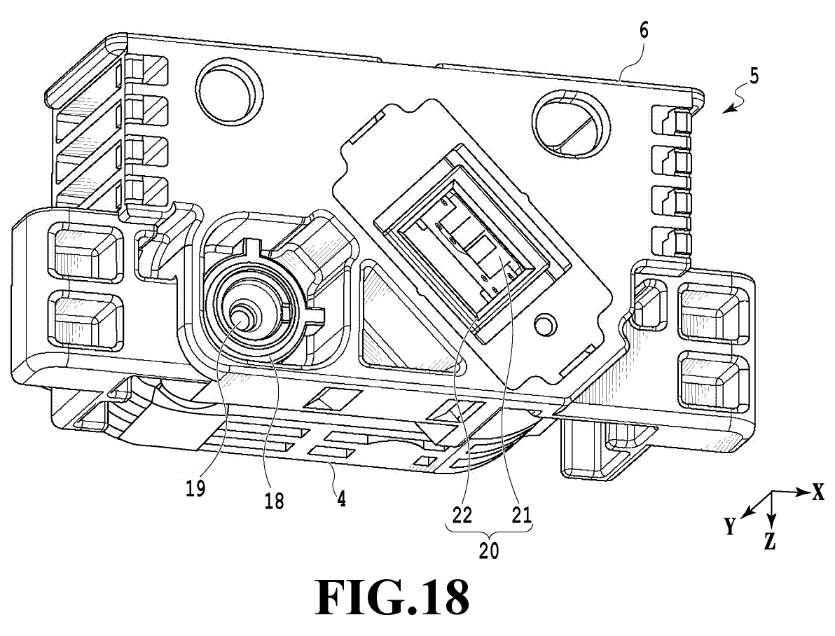

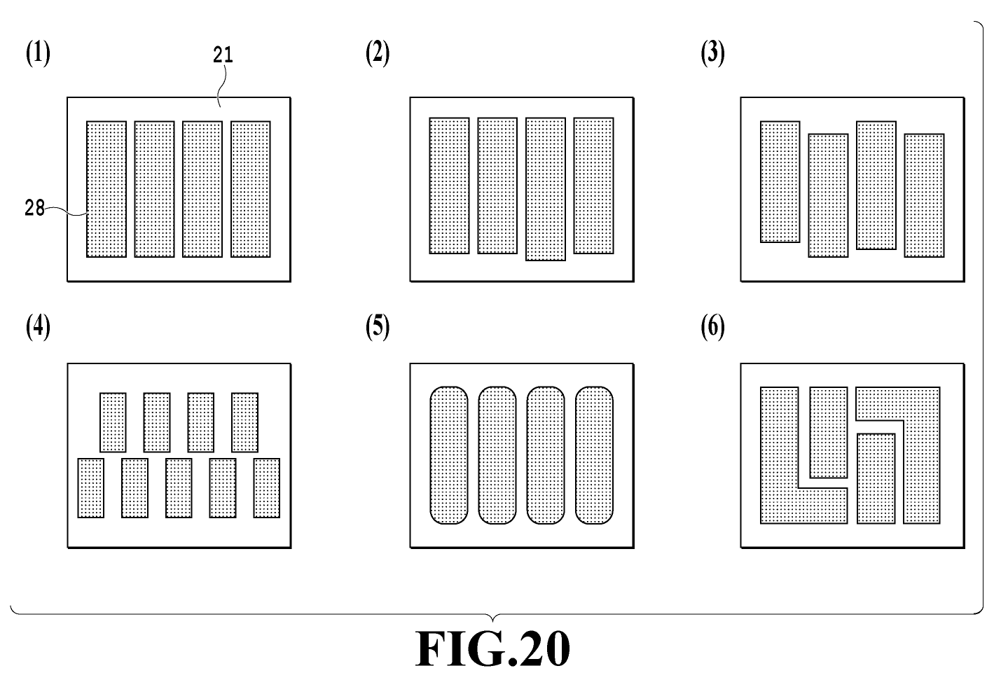

Also, as illustrated in FIG. 18, the liquid supply member 5 can include the electrical connection part 20 configured to be connectable to a later-described electrical contact 1010 provided to the liquid ejection apparatus. More specifically, the electrical connection part 20 is a memory element board housing part 22 that houses a memory element board 21. The memory element board 21 is a chip-shaped board including a memory element storing information on the color of the ink, information on the remaining amount of the ink, and so on. In practice, the memory element board 21 is directly connected to the electrical contact 1010 of the liquid ejection apparatus. Thus, the electrical contact 1010 of the liquid ejection apparatus is inserted into the memory element board housing part 22 and brought into contact with the memory element board 21 to be electrically connected. The electrical connection part 20 or the memory element board 21 and the memory element board housing part 22 can be provided at an end portion of the liquid supply member 5 in the -Y direction, i.e., an end portion of the liquid container 200 in the -Y direction. The shape of the electrical connection part 20 or the memory element board housing part 22 may be any shape but is desirably a quadrangular shape and particularly desirably a rectangular shape with long sides and short sides. It suffices that the memory element board 21 is configured to be housed in the memory element board housing part 22, and likewise its shape can be a quadrangular shape, and in one embodiment, may be a rectangular or square shape. The memory element board 21 may be provided with multiple pad electrodes 28 as illustrated in (1) to (6) in FIG. 20. FIG. 20 schematically illustrates examples of the arrangement of the multiple pad electrodes 28 as seen from a direction perpendicular to the board. While four pad electrodes 28 are provided in the example of (1) in FIG. 20, the number of pad electrodes is not limited to four and a necessary number of pad electrodes may be provided. Moreover, publicly known configurations can be used for the arrangement of the multiple pad electrodes 28, the shape of each pad electrode 28, and so on. For example, a bilaterally asymmetrical arrangement as illustrated in (2) or (3) in FIG. 20 may be employed. Alternatively, an arrangement with two rows of pad electrodes arrayed on upper and lower sides as illustrated in (4) in FIG. 20 may be employed. Still alternatively, a non-rectangular shape or shapes as illustrated in (5) and (6) in FIG. 20 may be employed. Yet sill alternatively, an arrangement in which the center of gravity of the multiple pad electrodes 28 as a whole does not coincide with the center of gravity of the memory element board 21 as illustrated in (2) in FIG. 20, for example, may be employed.

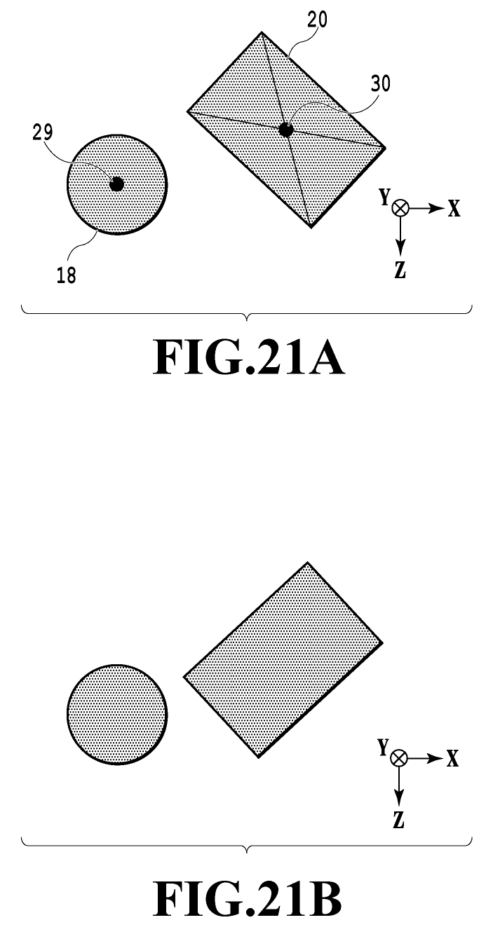

Configurations of the electrical connection part 20 in the present disclosure will be described below with reference to FIGS. 21A and 21B. Consider a case where the electrical connection part 20 is projected on a plane perpendicular to the direction in which the liquid container 200 is mounted (-Y direction). The electrical connection part 20 can be arranged such that, in this case, the longitudinal edges of the projection of the electrical connection part 20 intersect the direction of gravity (-Z direction) in the orientation in which the liquid container 200 is mounted to the liquid ejection apparatus (mounted orientation) at an angle of less than 90°. Additionally, the end surface of the liquid supply part 18 in the -Y direction (the surface of the liquid supply part 18 on the second end 19 side) will now be considered. The memory element board housing part 22 can be arranged such that the longitudinal edges of the memory element board housing part 22 at this end surface intersect the direction of gravity (-Z direction) in the mounted orientation in which the liquid container 200 is mounted to the liquid ejection apparatus at an angle of less than 90°.

This means that the electrical connection part 20 or the memory element board housing part 22 is obliquely arranged in a view from the direction in which the liquid container 200 is mounted (-Y direction) (hereinafter this will also be referred to as "oblique arrangement"). Oblique arrangement as above is not employed in conventional liquid containers (hereinafter such an arrangement will be referred to also as "horizontal arrangement"). In the horizontal arrangement, the longitudinal edges of the projection of the electrical connection part 20 or the memory element board housing part 22 do not intersect the direction of gravity in the mounted orientation (-Z direction) or intersects the direction of gravity in the mounted orientation (-Z direction) at 90°. In case the liquid (ink) leaks from the liquid supply part, the oblique arrangement makes it difficult for the liquid (ink) to flow onto the electrical connection part 20 or the memory element board 21. Also, obliquely arranging the electrical connection part 20 or the memory element board housing part 22 makes it possible to downsize the liquid supply part 18 and therefore desirable from the viewpoint of reducing the amount of plastic. Specifically, with the conventional horizontal arrangement, using a larger memory element board 21 requires increasing the size of the liquid supply part 18 as well. With the oblique arrangement, however, it is possible to arrange the liquid supply part 18 without changing its size.

Now, the positional relationship in the direction of gravity (Z-axis direction) as seen from the direction of mounting the liquid container 200 (-Y side) is considered. As illustrated in FIG. 21, the liquid supply part 18 can be arranged to be offset from the electrical connection part 20 or the memory element board 21 and the memory element board housing part 22 in the -Z direction. The phrase "arranged to be offset" means as follows. Specifically, the phrase may mean a positional relationship in which a center of gravity 29 of the liquid supply part 18 is arranged on the +Z side relative to a center of gravity 30 of the electrical connection part 20 or the memory element board housing part 22. In a case where the shape of the opening is a circle, the center of gravity 29 is the center of the circle. Also, in a case where the shape of the memory element board housing part is a rectangle, the center of gravity 30 is the intersection of the diagonals. In case the liquid (ink) leaks from the liquid supply part, such a positional relationship makes it difficult for the liquid (ink) to flow onto the electrical connection part 20 or the memory element board 21.

As described above, the electrical connection part 20 or the memory element board housing part 22 is obliquely arranged. Here, in a case where the electrical connection part 20 or the memory element board housing part 22 is rectangular, there are two possible patterns for the oblique direction relative to the liquid supply part 18. The first pattern corresponds to a case where the electrical connection part 20 or the memory element board housing part 22 is obliquely arranged such that its longitudinal edges are situated closer to the liquid supply part 18, as illustrated in FIG. 21A. The second pattern corresponds to a case where the electrical connection part 20 or the memory element board housing part 22 is obliquely arranged such that its transverse edges are situated closer to the liquid supply part 18, as illustrated in FIG. 21B. According to studies by the present inventors, both oblique arrangements are sufficiently effective but the first arrangement is desirable. This is due to the following reason. Specifically, in one embodiment, the lower ends of the longitudinal edges of the electrical connection part 20 or the memory element board housing part 22 in the -Z direction can be arranged to be separated away from the liquid supply part 18. In this way, the above-described effect of making it difficult for the liquid (ink) to flow onto the electrical connection part 20 or the memory element board 21 will be achieved at a higher level.

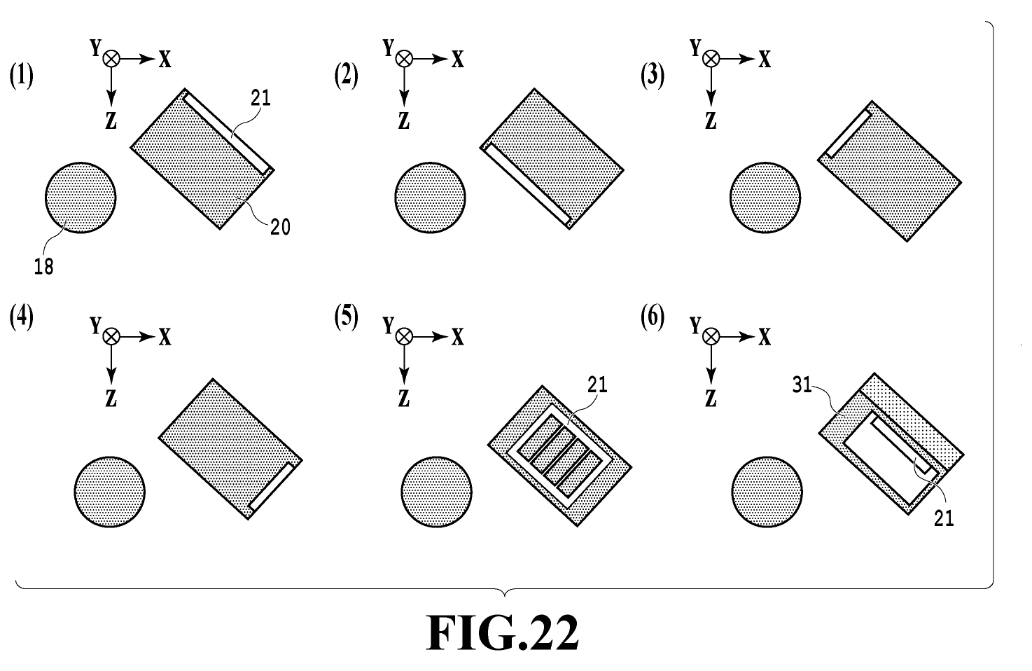

As illustrated in FIG. 19, the memory element board housing part 22 can be a space with the shape of a cuboid (including a cube) including an opening at the end of the liquid supply member 5 in the -Y direction and bored in the +Y direction. The opening at the end in the -Y direction is an opening through which to insert the electrical contact 1010 of the liquid ejection apparatus. The memory element board 21 is arranged on an inner surface of the memory element board housing part 22 serving as a cuboidal space. Here, the cuboidal space includes five inner surfaces, namely one bottom surface facing the opening and four side surfaces surrounding this bottom surface. As illustrated in FIG. 22, the memory element board 21 may be arranged on any one of these five surfaces. The memory element board 21 can be arranged on any one of the four side surfaces ((1) to (4) in FIG. 22) among these and particularly arranged on the farthest side surface from the liquid supply part 18 ((1) in FIG. 22). Otherwise, the memory element board 21 may be arranged on the bottom surface facing the opening as illustrated in (5) in FIG. 22, or a configuration with a memory element board holder 31 (memory element board support member) as illustrated in (6) in FIG. 22 may be employed.

Also, the memory element board 21 may be directly joined to an inner surface of the memory element board housing part 22 or provided with another member interposed therebetween. This other member may be the memory element board holder (memory element board support member) 31, as illustrated in (6) in FIG. 22. Specifically, the memory element board 21 is provided on the memory element board holder 31, and the memory element board holder 31 is provided in the memory element board housing part 22. In this case, the memory element board holder 31 can be mounted to be movable inside the memory element board housing part 22. With such a configuration, in a case where the electrical contact 1010 (a member provided with an electrical contact) of the liquid ejection apparatus is inserted into the memory element board housing part 22, the memory element board holder 31 moves to an appropriate position along the member of the liquid ejection apparatus. This makes it possible to electrically connect the memory element board 21 and the electrical contact 1010 more reliably. Without such a configuration, on the other hand, the electrical contact 1010 (a member provided with an electrical contact) of the liquid ejection apparatus may break or damage the memory element board 21 depending on how the user inserts the member. Also, having a configuration as described above makes it possible to absorb the manufacturing tolerance of the member of the liquid ejection apparatus, the memory element board housing part 22, or the like. Additionally, the memory element board holder 31 may be biased in a specific direction with an elastic member, such as a spring. The biasing direction in this case can be such a direction as to press the memory element board 21 against the electrical contact 1010 of the liquid ejection apparatus in the state where the electrical contact 1010 is inserted.

### (II) Liquid Ejection Apparatus (Recording Apparatus)

As described hereinabove, the liquid container 200 according to the present disclosure is intended to be housed inside a liquid ejection apparatus (recording apparatus) and used. The liquid ejection apparatus may be a commonly used inkjet printer, a commercial liquid ejection apparatus, or an industrial liquid ejection apparatus. In a case where the liquid container 200 is an ink pack, its ink capacity can be flexibly adjusted. It is practical to use an ink pack with a large ink capacity for a liquid ejection apparatus (recording apparatus) for a commercial use, an industrial use, or the like intended for large-volume printing or large-volume recording.

The liquid ejection apparatus includes an inkjet recording head. The inkjet recording head may be a full-line (page-wide) recording head. Examples of other types of heads include a serial-scan recording head which is reciprocally moved in a direction intersecting the direction of conveyance of the recording medium.

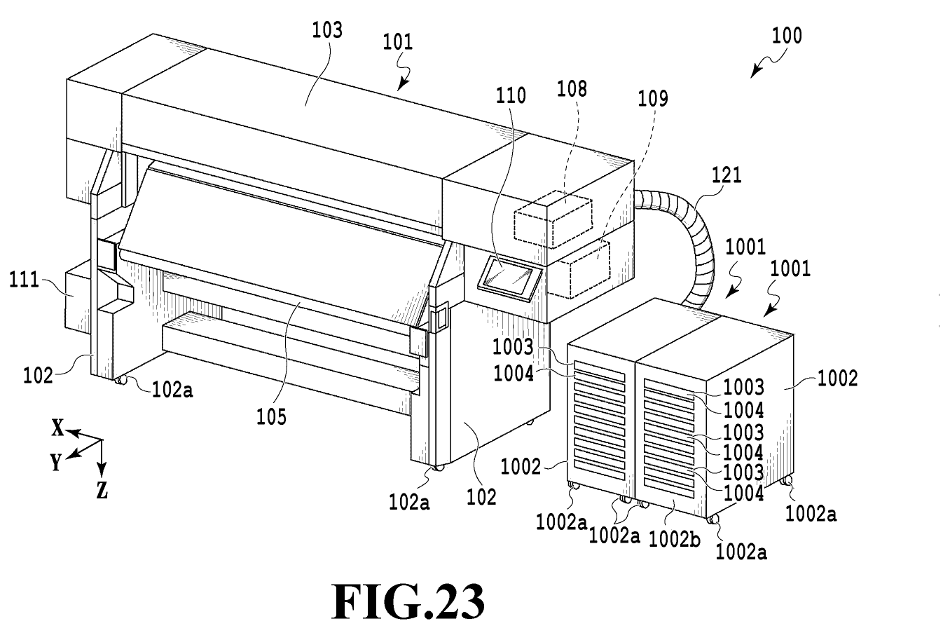

A liquid ejection apparatus (recording apparatus) 101 according to the present disclosure will be described with reference to FIG. 23. FIG. 23 is a schematic perspective view of a system 100 including the liquid ejection apparatus (recording apparatus) 101 and liquid supply apparatuses 1001 according to the present disclosure. The liquid ejection apparatus (recording apparatus) 101 includes the liquid supply apparatuses (referred to also as "case housing units" herein) 1001 as housing spaces each capable of housing the liquid container 200 according to the present disclosure. It is desirable to prepare a number of liquid supply apparatuses (case housing units) 1001 corresponding to the number of liquid (ink) colors. For example, in a case of using cyan, magenta, yellow, and black inks, four liquid supply apparatuses (case housing units) 1001 are provided and configured to house the liquid containers 200 storing the respective inks. In this case, the configuration may be such that the multiple liquid supply apparatuses (case housing units) are arrayed in the width of the liquid ejection apparatus (recording apparatus) or arrayed in the height direction of the liquid ejection apparatus (recording apparatus).

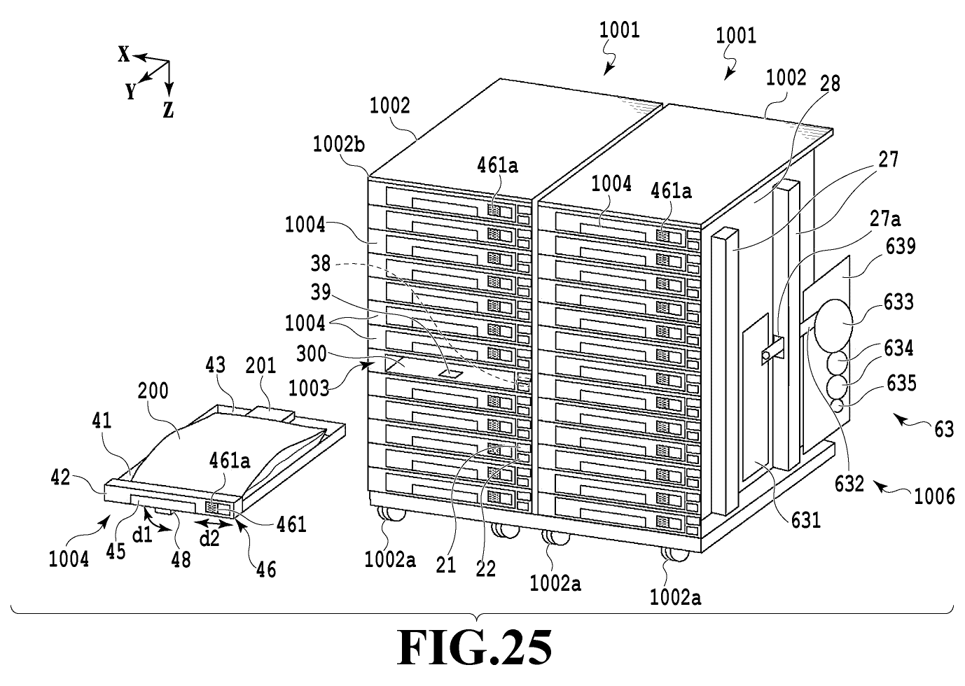

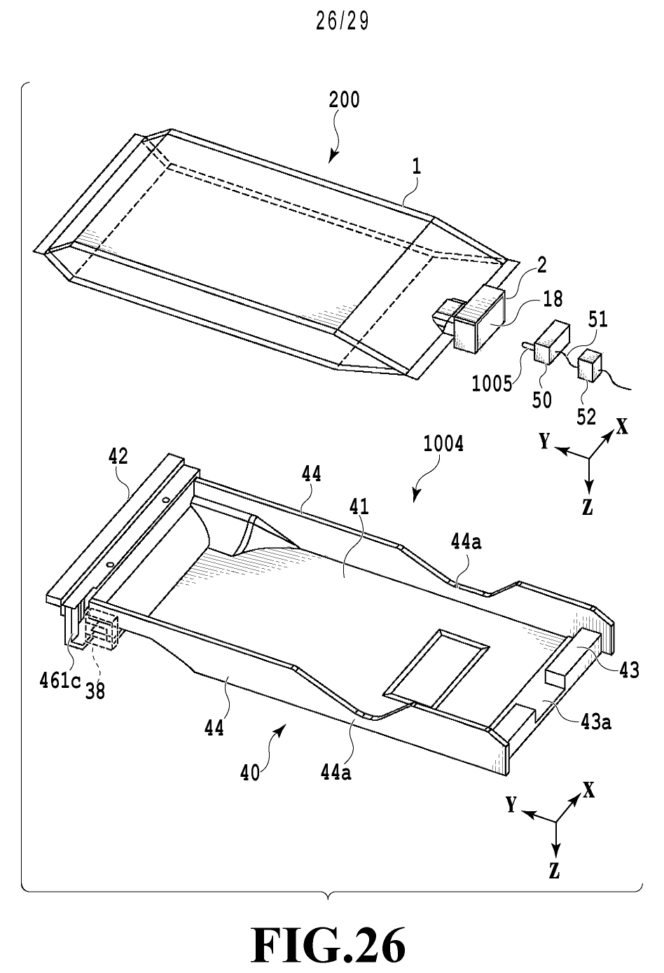

FIG. 25 illustrates a perspective view of the liquid supply apparatuses (case housing units) 1001. In the present embodiment, the liquid supply apparatuses (case housing units) 1001 include cases (referred to also as "trays," "support units," or the like in the specification) 1004 in the form of drawers or the like removably set therein. As illustrated in FIG. 26, in each support unit (case) 1004, the liquid container 200 is placed in a removable manner. The support units (cases) 1004 are mountable to the liquid supply apparatus (case housing unit) alone without the liquid container 200 placed therein. The liquid supply apparatuses (case housing units) 1001 include insertion ports 300 for inserting the support units (cases) 1004 into the liquid supply apparatus (case housing unit) 1001 (FIG. 25). The liquid supply apparatuses (case housing units) 1001 can include multiple sets of linear guide rails each formed of one or more convex or concave portions extending in the depth direction in order to guide movement of the support units (cases) 1004 for setting and removing them.

The liquid supply apparatuses (case housing units) 1001 include sets of a liquid injection part 1005 and an electrical contact 1010, which are configured to be operably connectable respectively to the liquid supply part 18 and the electrical connection part 20 provided to the liquid supply member 5 of the liquid container 200 described above. FIG. 26 is a view illustrating a portion of a support unit (case) 1004 where the liquid injection part 1005 and the electrical contact 1010 are provided. The support units (cases) 1004 may include a positioning member configured to be engageable with a positioning portion provided to the liquid supply member 5 of the liquid container 200. Specifically, the support units (cases) 1004 have a concave shape with which the above-described second protruding portions 17 provided on the liquid supply member 5 of the liquid container 200 are engageable.

The liquid ejection apparatus (recording apparatus) includes supply channels through which to supply the liquids (inks) to the recording head from the liquid containers 200 placed in the respective support units (cases) and set in the liquid supply apparatuses (case housing units). Each supply channel is in fluid communication with the liquid injection part 1005 and may include a supply tube having flexibility or the like. The liquid ejection apparatus (recording apparatus) may be provided with a pump and a pressure control mechanism to supply the liquids (inks) in the liquid containers 200 to the recording head.

The liquid ejection apparatus, the liquid supply apparatuses (case housing units), and the support units (cases) will be described below in further detail.

### Liquid Ejection Apparatus

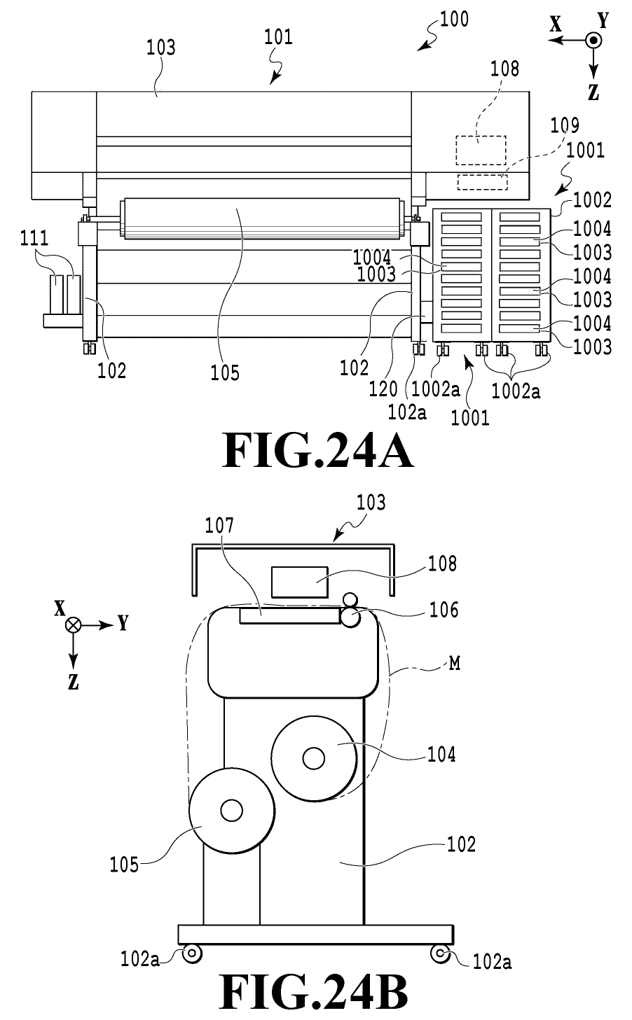

The liquid ejection apparatus 101 will be described. FIG. 24B is a diagram of an internal structure of the liquid ejection apparatus 101. A main body 103 of the liquid ejection apparatus 101 is supported on left and right stands 102. Each stand 102 is provided with casters 102a, allowing the liquid ejection apparatus 101 to be moved on the floor relatively easily. A feeding unit 104 and a winding unit 105 are arranged under the main body 103. In the present embodiment, a recording medium M is a roll sheet, and the feeding unit 104 includes a shaft around with which the recording medium M is wound. The winding unit 105 includes a shaft around which to wind up the recording medium M. In the present embodiment, a roll sheet can be used as the recording medium M, but the recording medium M may be a cut sheet.

The main body 103 is provided with a conveyance unit 106. The conveyance unit 106 includes a drive roller and a driven roller and holds the recording medium M fed from the feeding unit 104 between the nip portions of these rollers. The recording medium M is conveyed onto a platen 107 by rotation of the drive roller. A liquid ejection head 108 is arranged to face the platen 107. The liquid ejection head 108 is a recording head that forms an image by ejecting the liquids (inks). The liquids (inks) are ejected from the liquid ejection head 108 onto the recording medium M conveyed onto the platen 107 to form an image on the recording medium M.

The liquid ejection head 108 includes ejection energy generation elements, such, for example, as electrothermal conversion elements (heaters) or piezoelectric elements, and ejects the liquids (inks) from its ejection orifices. In a case of using electrothermal conversion elements, the liquid ejection head 108 generates bubbles in the liquids (inks) by causing those elements to heat, and eject the liquids (inks) from the ejection orifices using the energy of the generated bubbles. The recording method of the liquid ejection head 108 may be a serial-scan method or a full-line method (page-wide method). In the case of the serial-scan method, the liquid ejection head 108 is mounted on a carriage and reciprocally moved in the X-axis direction. Causing the liquid ejection head 108 to eject the liquids (inks) while moving it in the X-axis direction will be referred to as "recording scan." An operation of conveying the recording medium M and a recording scan of the liquid ejection head 108 are alternately repeated to form an image on the recording medium M. In the present embodiment, the serial-scan method is assumed to be employed. In the case of the full-line method, a long liquid ejection head 108 extending in the X-axis direction is used to record an image while continuously conveying the recording medium M.

The recording medium M after the image recording is wound up by the winding unit 105. The recording medium M after the image recording will be cut by the user with a pair of scissors or the like or automatically cut by a cutter (not illustrated).

A recovery unit 109 is arranged in the main body 103. The recovery unit 109 is arranged outside the recording region (ejection region) for the liquid ejection head 108, and performs a process for recovering and maintaining the ejection performance of the liquid ejection head 108. Examples of such a process include preliminary ejection and a process of sucking remaining liquids (inks) and the like from the ejection orifices of the liquid ejection head 108. As illustrated in FIG. 24A, the liquid ejection head 108 is moved to above the recovery unit 109 in a case where it needs the recovery process.

In the present embodiment, the stands 102 also support the feeding unit 104 and the winding unit 105, which are heavy in weight, while supporting the main body 103. Hence, the stands 102 are arranged at positions slightly outward of the side edges of the recording medium M in the ±X direction. The main body 103 incorporating the recovery unit 109 overhangs to the outer side in the +X direction beyond the stands 102. The main body 103 also overhangs to the opposite outer side in the -X direction beyond the recording medium M. This portion incorporates a mechanism that moves the carriage (not illustrated) carrying the liquid ejection head 108 and so on.

As illustrated in FIG. 23, an operation panel 110 is provided on the front side of the main body 103. The operation panel 110 is a touch panel, for example, and capable of accepting input of various settings related to recording, displaying the statuses of recording jobs, and performing other similar operations.

The liquid ejection apparatus 101 is also provided with a waste liquid cartridge 111. The waste liquid cartridge 111 is arranged under an end portion of the main body 103 on the opposite side from the liquid supply apparatuses 1001 (-X side). Placing the waste liquid cartridge 111 under the overhanging portion of the main body 103 on the -X side reduces the installation area of the liquid ejection apparatus 101.

The waste liquid cartridge 111 collects waste liquids (waste liquids (inks) and the like) sucked by the recovery unit 109. The waste liquid cartridge 111 may be arranged near the recovery unit 109. However, in the present embodiment, the waste liquid cartridge 111 is arranged in a space under an end portion of the main body 103 to reduce the installation area of the liquid ejection apparatus 101.

### Liquid Supply Apparatuses (Case Housing Units)

The liquid supply apparatuses (case housing units) 1001 are apparatuses supply the liquid ejection apparatus 101 with the liquids (inks) to be ejected from the liquid ejection head 108. The liquid supply apparatuses include a box-shaped main body 1002 in which multiple slots 1003 are formed. Casters 1002a are provided on the bottom surface of the main body 1002, allowing the liquid supply apparatus 1001 to be moved on the floor relatively easily. The multiple slots 1003 are arrayed in the Z-axis direction in the front surface of the main body 1002. In each slot 1003, a support unit 1004 is removably inserted in the Y-axis direction. The support unit 1004 supports the liquid container 200.

In each slot 1003, a tube that connects the liquid container 200 and the liquid ejection apparatus 101 is provided. Each tube is connected to the liquid ejection apparatus 101 through a single hose 121 housing all tubes. The liquid (ink) in the liquid container 200 will be supplied to the liquid ejection head 108 through the tube.

The height of the liquid supply apparatuses 1001 is set lower than the lower surface of the end portion of the main body 103 of the liquid ejection apparatus 101 overhanging to the +X side. In this way, the liquid supply apparatuses 1001 can be accommodated under the main body 103 as illustrated in FIG. 24A. The liquid supply apparatuses 1001 can be moved in the X-axis direction to a position where it comes into contact with the stand 102. As illustrated in FIG. 24A, a coupling member 120 can be used to fix the liquid supply apparatuses 1001 to the main body stand 102. In a case of moving the system 100, all components can be integrated and moved.

The system 100 in the present embodiment is provided with two liquid supply apparatuses 1001 and thus able to use more liquid containers 200 than otherwise. It is advantageous to provide multiple liquid supply apparatuses 1001 as above, for example, in a case of increasing the number of liquid (ink) colors for the purpose of achieving high image quality or increasing the number of liquids (inks) of the same color for the purpose of achieving high productivity. In such a case, as in the present embodiment, a layout in which some or all of the liquid supply apparatuses 1001 overlap the liquid ejection apparatus 101 in the X-axis direction may be employed as in the present embodiment to reduce the installation area of the system 100. Meanwhile, in the present embodiment, one of the two liquid supply apparatuses 1001 is completely within the size of the liquid ejection apparatus 101 in the X-axis direction. The size relationship is such that, in a case where two or more liquid supply apparatuses 1001 are provided, some of them slightly sticks out from the system 100 in the X-axis direction.

### Support Units (Cases)

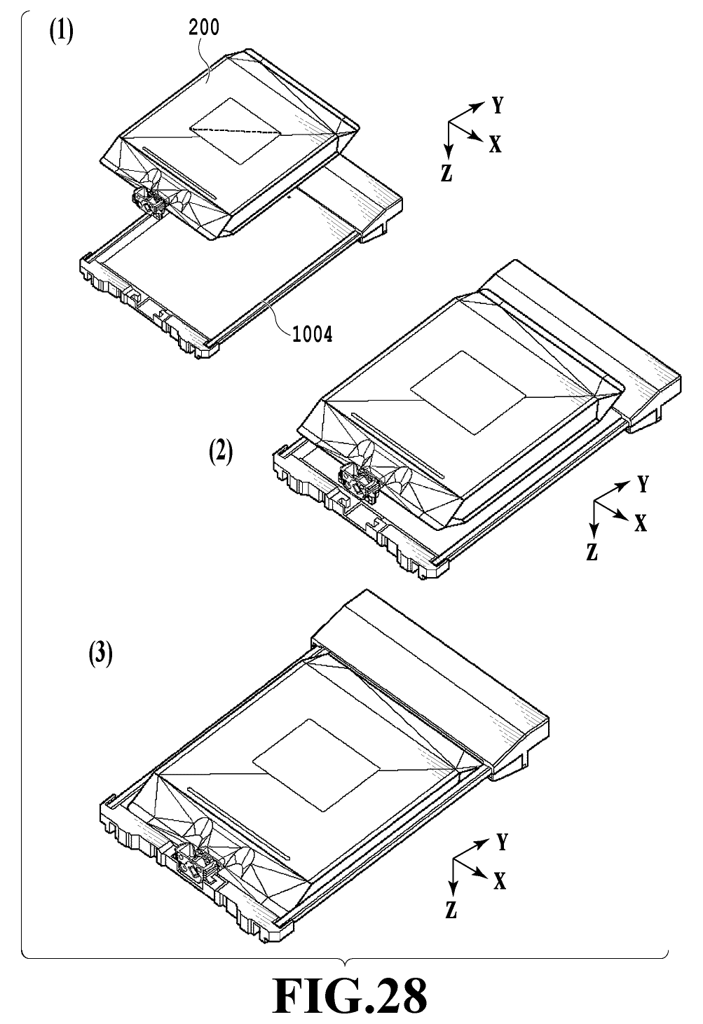

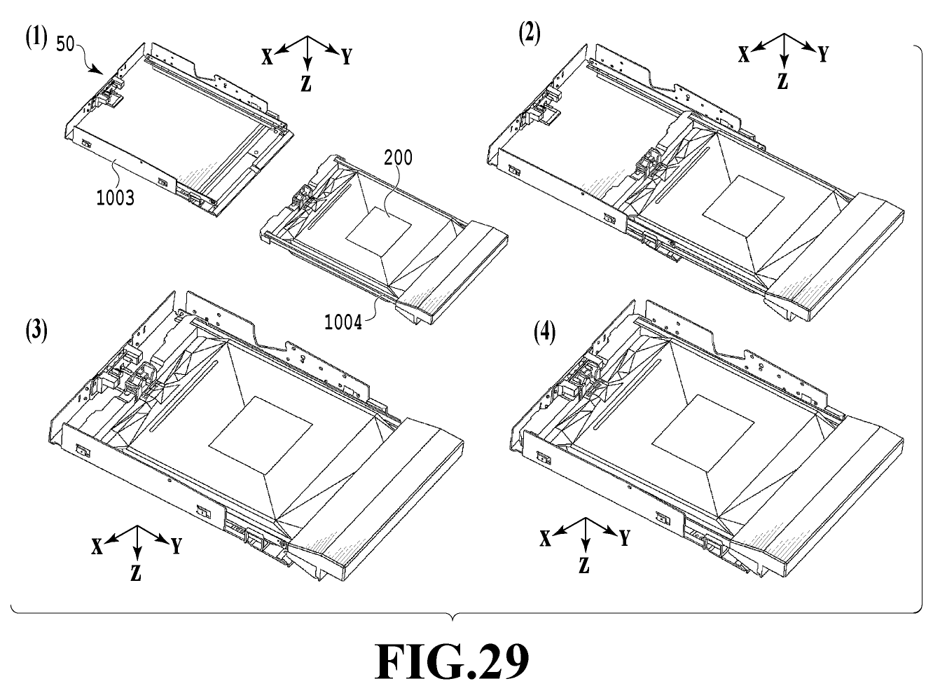

FIG. 25 is a partially exploded perspective view of the liquid supply apparatuses (case housing units) 1001, illustrating a state where one support unit (case) 1004 is removed from the corresponding slot 1003. FIG. 25 also illustrates a state where a side wall as one of the outer walls of a liquid supply apparatus 1001 is removed, exposing the internal mechanism. FIG. 26 is a perspective view of the liquid container 200 and a support unit (case) 1004. As illustrated in FIGS. 28 and 29, in the present embodiment, the liquid container 200 is placed in the support unit 1004 ((1)→(2)→(3) in FIG. 28) and the support unit 1004 in which the liquid container 200 is placed is set in a slot 1003 ((1)→(2)→(3)→(4) in FIG. 29). As a result, the liquid container 200 is housed in the liquid supply apparatus 1001. Then, as described above, the liquid (ink) is supplied from the liquid supply apparatus 1001 to the liquid ejection apparatus 101 so that an image can be recorded. The method of supplying the liquid (ink) from the liquid container to the liquid ejection apparatus is not limited to the one in the present embodiment. For example, a system in which the liquid container is directly mounted on the liquid ejection apparatus without using a support unit or the like is possible.

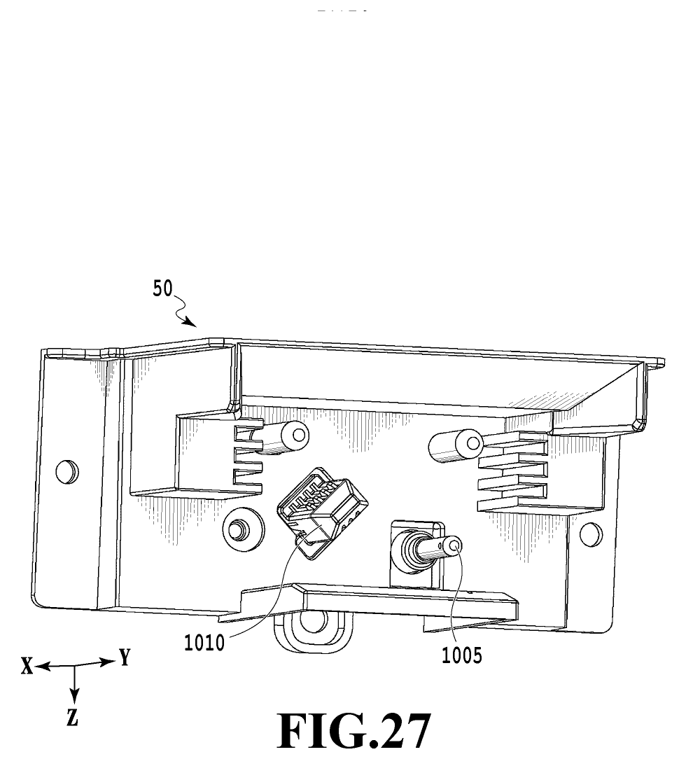

At the bottom of each slot 1003, the main body 1002 includes a needle-type liquid injection part 1005 to be inserted into the liquid supply part 18 of the liquid container 200, and an electrical contact 1010 configured to be connectable to the electrical connection part 20 of the liquid container 200 by being inserted into the electrical connection part 20. FIG. 27 is a view illustrating a portion of a support member 50 where the liquid injection part 1005 and the electrical contact 1010 are provided. In a case where the liquid injection part 1005 is inserted into and connected to the liquid supply part 18, the valve mechanism 23 (see FIG. 19) shifts to an open state as a result of the insertion of the liquid injection part 1005. The liquid injection part 1005 is supported on the support member 50, which has a block shape, and is connected to a tube 51. The liquid injection part 1005 forms a channel via which to cause the liquid stored in the liquid storage part 1 to flow out into the liquid ejection apparatus 101, which is the supply destination. The liquid having flowed out into the liquid injection part 1005 is supplied to the liquid ejection apparatus 101 through the tube 51. An electrically powered channel valve 52 is provided at an intermediate portion of the tube 51. The tube 51 can be closed and opened by closing and opening the channel valve 52. The liquid supply part 18 may be provided with a pump, a pressure control mechanism, and so on in order to supply the liquid (ink) in the liquid container 200 to the liquid ejection head 108 through the tube 51.

The support units 1004 includes a support part 40 that supports the liquid container 200 and is in the form of a tray as a whole on which the liquid container 200 is placed in a lying posture. The support unit 1004 is displaceable in the Y-axis direction between a housing position at which the liquid container 200 is housed in the main body 1002 and a drawn-out position at which the liquid container 200 is exposed to the outside of the main body 1002. In FIG. 25, one support unit 1004 is at the drawn-out position while all of the other support units 1004 are at the housing position. At the drawn-out position, the liquid container 200 can be replaced. At the housing position, the liquid stored in the liquid container 200 can be supplied to the liquid ejection apparatus 101. In the present embodiment, in a case where a support unit 1004 is at the drawn-out position, it is separated from the slot 1003. However, the drawn-out position may be a position at which an end portion of the support unit 1004 is held within the slot 1003, and only needs be a position of the support unit 1004 at which the liquid container 200 can be replaced. Also, the slots 1003 can include multiple sets of linear guide rails each formed of one or more convex or concave portions extending in the Y-axis direction in order to guide movement of the support unit 1004. FIG. 29 is a view illustrating how a support unit 1004 in which the liquid container 200 is placed is moved along the guide rails provided in the slot 1003 to move from the drawn-out position to the housing position.

The support part 40 includes a placement surface 41 on which to place the liquid container 200. The four sides of the placement surface 41 are defined by left and right side plates 44, a front end portion 42, and a rear end portion 43. A notched portion 44a is formed in the side plates 44. A concave portion 43a in which to place an exit member 201 is formed in the rear end portion 43. The support part 40 may include a positioning member configured to be engageable with a positioning portion provided to the liquid supply member 5 of the liquid container 200. Specifically, the support part 40 has a concave shape with which the above-described second protruding portions 17 provided on the liquid supply member 5 of the liquid container 200 are engageable. (2) and (3) in FIG. 28 are views illustrating how the second protruding portions 17 provided on the liquid supply member 5 engage with the concave portion of the support part 40.

As described hereinabove, the present disclosure is a technique capable of guaranteeing the performance of a liquid container while reducing the amount of plastic to be used for the liquid container. Accordingly, the technique described in the specification can contribute to realizing a sustainable society, such as a decarbonized society and recycling-oriented society.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to provide a liquid container that supplies an ink with stable concentration.

What is claimed is:

1. A liquid container comprising:
a liquid storage part configured to store a liquid; and
a liquid supply member provided at a first edge of the liquid storage part, wherein
the liquid supply member includes a liquid supply part for supplying the liquid stored in the liquid storage part to an external destination,
the liquid supply part includes a liquid inlet portion in an inside direction of the liquid storage part,
the liquid inlet portion includes
a first inlet channel located in an opposite direction from a direction in which gravity is exerted in the liquid storage part, and
a second inlet channel located in the direction in which gravity is exerted in the liquid storage part, and
channel resistance of the second inlet channel is lower than channel resistance of the first inlet channel.

2. The liquid container according to claim 1, wherein
the liquid supply member is arranged in a sealed portion provided at the first edge of the liquid storage part,
the liquid inlet portion includes a first end facing in a direction toward the inside of the liquid storage part, and
the first end is located in the sealed portion.

3. The liquid container according to claim 1, wherein
the liquid storage part has the first edge and a second edge of the liquid storage part opposing the first edge, and has a length LA in a direction toward the second edge from the first edge,
the liquid supply member has a length LB in the same direction from the first edge toward the second edge, and
the length LA and the length LB have a relationship of LA/LB > 3.4.

4. The liquid container according to claim 1, wherein
at least part of the first inlet channel is covered by a first surface of the liquid storage part on the opposite side from the side in the direction in which gravity is exerted,
at least part of the second inlet channel is covered by a second surface of the liquid storage part on the side in the direction in which gravity is exerted, or
at least part of the first inlet channel and at least part of the second inlet channel are covered by the first surface and the second surface of the liquid storage part, respectively.

5. The liquid container according to claim 1, wherein
the channel resistance of the first inlet channel and the channel resistance of the second inlet channel result from lengths of the respective inlet channels, and
the length of the first inlet channel is shorter than the length of the second inlet channel.

6. The liquid container according to claim 1, wherein
the channel resistance of the first inlet channel and the channel resistance of the second inlet channel result from sizes of openings of the respective inlet channels, and
the size of the opening of the first inlet channel is smaller than the size of the opening of the second inlet channel.

7. The liquid container according to claim 1, wherein one or both of the first inlet channel and the second inlet channel include a beam portion.

8. The liquid container according to claim 1, wherein the first inlet channel and the second inlet channel are provided with a filter.

9. The liquid container according to claim 1, wherein an opening of the first inlet channel and an opening of the second inlet channel are oriented toward the inside of the liquid storage part.

10. The liquid container according to claim 1, wherein an opening of the first inlet channel and an opening of the second inlet channel are oriented in a direction toward a first surface of the liquid storage part and a direction toward a second surface of the liquid storage part, respectively.

11. The liquid container according to claim 1, wherein the liquid supply part and the liquid supply member are formed integrally with each other.

12. A liquid ejection apparatus comprising:
a liquid ejection head; and
a liquid supply apparatus configured to supply a liquid to the liquid ejection head, wherein
the liquid supply apparatus includes a liquid container including
a liquid storage part configured to store a liquid, and
a liquid supply member provided at a first edge of the liquid storage part,
the liquid supply member includes a liquid supply part for supplying the liquid stored in the liquid storage part to an external destination,
the liquid supply part includes a liquid inlet portion in an inside direction of the liquid storage part,
the liquid inlet portion includes
a first inlet channel located in an opposite direction from a direction in which gravity is exerted in the liquid storage part, and
a second inlet channel located in the direction in which gravity is exerted in the liquid storage part, and
channel resistance of the second inlet channel is lower than channel resistance of the first inlet channel.
